(19) United States
(12) Patent Application Publication
(10) Pub. No.: US 2025/0299158 A1
(43) Pub. Date: Sep. 25, 2025

(54) QUANTUM SYSTEM FOR A CENTRALIZED AND CLOUD-BASED, REAL-TIME ON-SHELF MERCHANDISE INVENTORY MONITORING SYSTEM

(71) Applicant: POGGI, INC., Westport, CT (US)

(72) Inventors: Ye Yang Sun, Westport, CT (US); Daniel Ben Rothman, New York, NY (US); Meng Zhang, Shanghai (CN)

(73) Assignee: POGGI, INC., Westport, CT (US)

(21) Appl. No.: 19/230,321

(22) Filed: Jun. 6, 2025

Related U.S. Application Data
(63) Continuation of application No. PCT/US2024/010833, filed on Jan. 9, 2024.
(60) Provisional application No. 63/438,571, filed on Jan. 12, 2023.

(51) Int. Cl. G06Q 10/087; B25J 9/16; G06N 10/80; G06V 10/82

(52) U.S. Cl. CPC G06Q 10/087; B25J 9/1679; G06N 10/80; G06V 10/82

(57) ABSTRACT

There is provided a Quantum system for a centralized and cloud-based, real-time merchandise inventory monitoring system. This system comprises multiple layers or shells αₚ, αₐ, α_{d}, αₑ, α_{c}, and α_{c1} represent perception, analog signals, digital signals, Ethernet processing, the cloud database, and client apps and processes, respectively. Connections βₚₐ, β_{ad}, β_{de}, β_{ec} and β_{cc1} represent (1) analog signal generation, (2) analog signal-to-digital signal conversion, (3) signal processing and real-time inventory data generation in the Ethernet, (4) data transferred from the Ethernet space to the cloud database, and (5) client apps and processes sending requests for data and services to the cloud database through the public API. These connections are represented from lower to higher levels, respectively. A node comprises ap, da and ad. The multiple layers or shells perform as a quantum structure working for data generation and communications. One embodiment of a shelving system comprised by individual tracks with photoresistors is used to show the system monitoring the real-time on shelf merchandise inventory.

### CROSS REFERENCE TO RELATED APPLICATIONS

The present application claims the benefit under 35 U.S.C. § 120 of International Patent Application No. PCT/US2024/010833, filed on Jan. 9, 2024, which in turn claims the benefit under 35 U.S.C. § 119 of U.S. Provisional Patent Ser. No. 63/438,571, filed on Jan. 12, 2023.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### 1. Field of the Disclosure

The present disclosure relates to monitoring of merchandise inventory and collecting and managing data about the inventory. Real-time, on-shelf merchandise inventory is a critical issue in the retail industry. Cash registers or self-checkout shopping cart with build-in cameras and scales record merchandise through a scanning process, but do not include items that are not scanned due to theft, improper arrangement or other factors. Empty shelves account for significant loss of revenue. Furthermore, in the e-commerce era, efficient cash flow necessitates effective, not merely sufficient, merchandise inventory levels. Moreover, the interaction of real-time, on-shelf inventory, sales revenue and cash flow is the focus of intelligent or smart shelving, and display systems involving real-time interactions, centralized and cloud-based systems, cashier-less store, driverless supply chain, learning processes, Internet of things (IoT), 5^{th} or 6^{th} generation (5G or 6G) networks, blockchain, robotics, warehouse automation, new types of chips, sensors or sensing devices, big data, data analysis and data mining, in-time delivery and other artificial intelligence (AI) technology development. The above-mentioned technologies represent a new phase of smart shelving/network/cloud systems. The present document is directed to features of these technologies and the architecture and design of the system.

The following papers give a brief guidance of recent technologies applied for e-commerce in retail chain stores: (1) Distributed Computing and Artificial Intelligence, edited by Kenji Matsui et al, DCAI, 2021, proposed within the Preface that “distributed computing performs an increasingly important role in modern signal/data processing, information fusion, and electronic engineering (e.g., electronic commerce, mobile communications, and wireless devices). Particularly, applying artificial intelligence in distributed environments . . . for IoT, IIOT (Industrial IoT), big data, blockchain . . . from personal laptops to edge/fog/cloud computing systems available for parallel and distributed computing”; (2) “A Review of Evolutionary Trends in Cloud Computing and Applications to the Healthcare Ecosystem”, Mbasa Joaquim Moto, et al., vol. 2021, Article ID 1843671, describes new challenges and opportunities in IoT, edge computing, fog computing and cloud computing; (3) “The Digitization of the World From Edge to Core,” David Reinsel, et al., November 2018, describes the growing global data and digital transformation competency; (4) a German team led by Jurgen Sturm worked on indoor navigation and virtual shopping from June 2014 to September 2015 by use of robotics; (5) “Multi-Task Learning with Sequence-Conditioned Transportation Networks”, to appear in IEEE, 2022, describes a vision-based, end-to-end system architecture and sequence-conditioned transporter network that significantly improved pick-and-place performance on novel 10 multi-task benchmark problems; (6) “Implicit Behavioral Cloning,” Adrian Wong, et al., CORL, 2021, reveals that robots with implicit policies can learn complex and remarkably subtle behaviors used in contact-rich tasks from human demonstrations, including high combinatorial complexity with 1 mm precision; (7) “Faster R-CNN: Towards Real-Time Object Detection with Region Proposal Networks,” Shaoqing Ren, Kaiming He, et al., (arXiv: 1506.01497, 4 Jun. 2015 (v1), last revised 6 Jan. 2016 (v3), indicates that trained end-to-end RPNs generate high-quality region proposals.

### 2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

U.S. Pat. No. 11,222,306 is directed to a real-time on-shelf merchandise inventory monitoring method by use of a sensor or photoresistor under a light.

U.S. Pat. No. 11,064,816 is directed to a discrete gravity feed merchandise advancement system assembled for a real-time on-track merchandise inventory monitoring system.

U.S. Pat. No. 8,376,154 is directed to gravity-fed rolling shelving systems to be applied for merchandise restock by a robot.

U.S. Pat. No. 10,660,435 is directed to an in-door cooler racking/shelving system for the application of a real-time on-shelf merchandise inventory monitoring system.

U.S. Pat. No. 9,420,901 is directed to a power supply, in general, for low voltage plug-and-play display systems.

U.S. Pat. No. 9,375,098 is directed to a weighted-pusher rolling shelving assembly to be used as a measurement for merchandise inventory.

### SUMMARY

There is provided a Quantum system for a centralized and cloud-based, real-time merchandise inventory monitoring system. This system comprises multiple layers or shells αₚ, αₐ, α_{d}, αₑ, α_{c}, and α_{c1} represent perception, analog signals, digital signals, Ethernet processing, the cloud database, and client apps and processes, respectively. Connections βₚₐ, β_{ad}, β_{de}, β_{ec} and β_{cc1} represent (1) analog signal generation, (2) analog signal-to-digital signal conversion, (3) signal processing and real-time inventory data generation in the Ethernet, (4) data transferred from the Ethernet space to the cloud database, and (5) client apps and processes sending requests for data and services to the cloud database through the public API. These connections are represented from lower to higher levels, respectively. A node comprises ap, da and ad. The multiple layers or shells perform as a quantum structure working for data generation and communications. One embodiment of a shelving system comprised by individual tracks with photoresistors is used to show the system monitoring the real-time on shelf merchandise inventory.

The present document also discloses a centralized, cloud-based system for monitoring on-shelf merchandise in real-time. The system as an embodiment includes:
a shelving system having:
   (a) a shelf having:
      a track upon which the merchandise is moveably disposed;
      a motherboard having a network port to communicate with the in-store server, herein known as the Access Server;
      a plug-and-play system which includes data and power conductors which enable the communication of information between the motherboard and the track;
   (b) a plurality of photoresistors disposed in proximity to the track, wherein the photoresistors produce analog signals indicative of a quantity of the merchandise disposed on the track at any moment in time;
   (c) a unique identifier associated with at least one component selected from the group consisting of one of the photoresistors, a group of the photoresistors, the track, the motherboard, the plug-and-play system, and the shelf;
   (d) a plurality of binary decoders disposed on the track for polling the analog signals of each of the photoresistors; and
   (e) a microcontroller unit (MCU) disposed on the track, the MCU having a track application program interface (API), an analog to digital converter port for analog signal input, and an analog signal to digital signal converter,
   wherein the motherboard is disposed on the shelf for shelf Ethernet networking and for track connection though a network bus and a power bus via the plug-and play-system; and
an access server connected to the shelf via the network port of the motherboard of the shelf,
wherein the access server sends a request to scan each of the photoresistors to the MCU through the motherboard of the shelf, then the MCU gets the analog signals from the photoresistors as addressed by the binary decoder,
wherein the MCU then converts the analog signals to digital signals via the analog signal to digital signal converter, such that the digital signals are transmitted via the plug-and-play system to the motherboard and then to the access server via the network port, and
wherein the access server includes a system that processes data and writes the processed data to a cloud database, where client apps and processes (such as RT-POG) can access the processed data from the cloud database through an API.

The present document also discloses a system for tracking merchandise on a shelf. The system includes:
(a) an advancement device upon which an item of the merchandise is disposed, and which moves the item, by force of gravity, toward a front of the shelf;
(b) a light-sensitive component that produces an analog signal having a magnitude that is, over a continuum, indicative of an intensity of light (ambient or non-ambient light) that is incident thereon, where the intensity of the light is dependent on a position of the item with respect to a position of the light-sensitive component;
(c) a circuit that converts the analog signal to a digital datum having a value that is indicative of the magnitude; and
(d) an “access server” that:
   (i) receives the digital datum from the circuit;
   (ii) processes the digital datum and digital data indicative of magnitudes of intensities of light incident on other light-sensitive components on the shelf, thus yielding processed magnitudes;
   (iii) determines, from the processed magnitudes, along with mapping light-sensitive components to dimensions of merchandise items, a quantity of the merchandise on the shelf, and percentage of on-shelf inventory; and
   (iv) writes processed magnitudes, quantities, and percentages to a central cloud database, where processed data can be accessed by client apps and processes through an API.

The present document discloses a centralized, cloud-based system for monitoring on-shelf merchandise in real-time, and tracking merchandise on a shelf in the form of Quantum system:
(a) Photoresistors on a track upon which the merchandise is moveably disposed are used as perception to sense the existence of light in layer/shell αₚ;
(b) Analog signals on a track are generated in layer/shell αₐ to indicate a quantity of merchandise disposed on the track at any moment in time;
(c) The connection between layer/shell αₚ and layer/shell αₐ is the generation connection βₚₐ;
(d) Analog signals on a track are converted into digital signals in layer/shell α_{d}, wherein a plurality of binary decoder disposed on the track polls the analog signals of each photoresistor; and a microcontroller unit (MCU) disposed on the track has a track application program interface (API), an analog to digital converter port for analog signal input, and an analog signal to digital signal converter;
(e) The connection between layer/shell αₐ and layer/shell αₐ is the conversion connection β_{ad};
(f) The motherboard is disposed on the shelf for shelf Ethernet networking in layer/shell αₑ and for track connection though a network bus and a power bus via the plug-and-play system, i.e., the processing connection β_{de};
   whereby the MCU has converted the analog signals to digital signals via the analog signal to digital signal converter, such that the digital signals are transmitted via the plug-and-play system to the motherboard;
(g) The motherboard disposed on the shelf further connects an access server via the network port of the motherboard of the shelf in Ethernet layer/shell αₑ;
(h) Furthermore, the motherboard disposed on the shelf further connects Cameras, Access Points (AP) and/or 5G/6G Extenders via the network port to connect the electronic devices in Ethernet layer/shell αₑ;
(i) The access server sends a request to the MCU through the motherboard to scan every photoresistor on each track on the shelf, and the MCU gets the analog signals from the photoresistors, as addressed by the binary decoder, wherein the motherboard sends digital signals to the access server via the network port in Ethernet layer/shell αₑ. The access server is a system that processes the signals and converts the signals to processed data, and then writes the processed data to a cloud database in layer/shell α_{c}, where client apps and processes (such as RT-POG) can access the processed data from the cloud database through the public API via Cloud Connections β_{cc1} and β_{ec} through HTTP;
(j) The access server(s) is a physical device(s) in the edge layer while the relevant network is the edge network, wherein edge computing happens local to where data is being generated, right at “the edge” of a given application's network. Fog computing occupies a layer between Cloud computing and Edge computing. The Fog computing space can receive edge-layer data before it reaches the cloud layer and can optionally filter irrelevant data, analyze data for remote access, or inform localized learning models.
(k) The client apps and processes send requests to the cloud database through the public API in the API layer/shell. α_{API} connects access server software, i.e., signal processing software, in store or client's app (such as RT-POG) in Ethernet layer/shell αₑ via Cloud Connection β_{ec} and β_{cc1}, as shown in FIG. 0.

### BRIEF DESCRIPTION OF THE DRAWINGS

FIG. 0 is a quantum system of a centralized and cloud-based real-time on-shelf merchandise monitoring system.

FIG. 1 is a diagram of a centralized, cloud-based real-time shelf monitoring system.

FIG. 1A is a block diagram of a shelving system of FIG. 1.

FIG. 1B is a schematic diagram of the system of FIG. 1 showing a process from an analog signal produced by a photoresistor, to processed data.

FIG. 2 is a flowchart of a process that is performed by the system of FIG. 1, including two blocks, one block representing a shelf and the other block representing operations in the access server.

FIG. 2A is a flowchart of a processes performed by a track API when polled by an access server.

FIG. 3 is a table and a flowchart of Global Identification Numbers indicating a global retail system.

FIG. 4 illustrates a Unique Base-62 global Identification Number for components of a real-time inventory system.

FIG. 5 is an isometric view of a photoresistor array, on tracks, on a shelf.

FIG. 6 is a block diagram of a system network topology.

FIG. 7 is a block diagram of a binary decoder.

FIG. 8 is a block diagram of electronics on a shelf.

FIG. 9 is a flow diagram of data and from processes with Access Server Software.

FIG. 10 is an exploded top view of a track with a printed circuit board, which shows photoresistors of the printed circuit board distributed and connected along the length of the track.

FIG. 11 is an exploded side view of a track with a plug and play system, and a motherboard.

FIG. 12 is an illustration of some features of a plug-and-play system in the system of FIG. 1.

FIG. 13 is a bottom view of a track.

FIG. 14 is a block diagram of a shelf network.

FIG. 15 is a bottom view of a gondola.

FIG. 16 is an illustration of track navigation for a robot to deliver merchandise to a track.

FIG. 17 is a real-time, on-shelf inventory represented in a planogram.

FIG. 18 is a real-time planogram presentation.

FIG. 19 is an on-shelf inventory over time report.

FIG. 20 shows several exemplary time-inventory on-shelf curves.

FIG. 21 is a nationwide real-time on-shelf inventory map.

### DETAILED DESCRIPTION OF THE PREFERRED EMBODIMENTS

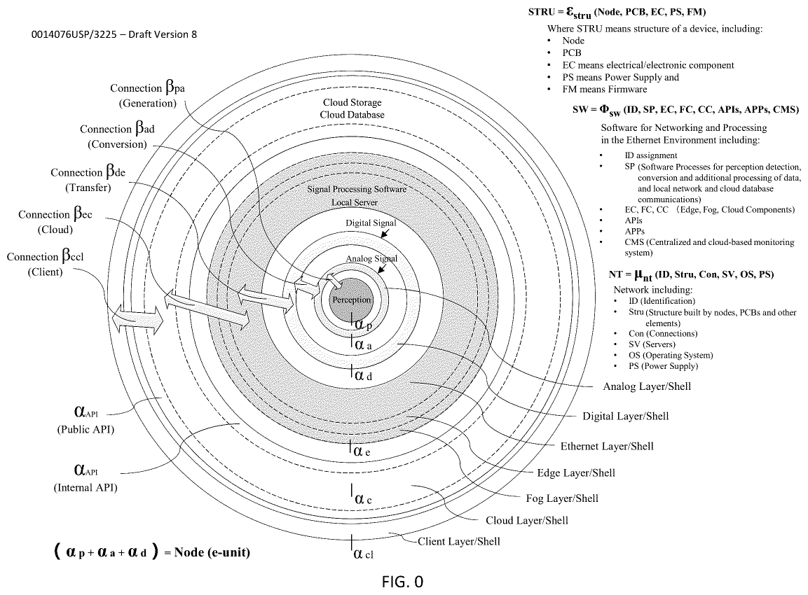

FIG. 0 describes a Quantum system for a centralized and cloud-based, real-time merchandise inventory monitoring system in stores.

A Quantum system is used to simulate the process of monitoring inventory from the generated analog signal to data transfer and communication. For a neural system, a sensory receiver processes stimulation, nerve impulse, and action potentials to complete sensory conduction. In short, the sensory neuron, or afferent neuron, is the neuron of the central nervous system, wherein, the nerve ending of the sensory nerve and afferent nerve fiber build the receptors.

Based on this concept of a neural system, an inventory monitoring system is established that includes a perception to sense the existence of merchandise. The perception then produces some amount of value through the connection βₚₐ in the layer/shell αₐ to generate an analog signal. Furthermore, the analog signal is converted to a digital signal though connection β_{ad} in layer/shell α_{d}. A node is defined as an “e-unit” comprising perception αₚ, an analog layer/shell αₐ, and a conversion layer/shell α_{d}. In this model, there is at least one Node in the FIG. 0.

Based on the above description, a node has a digital signal that is transferred to specific devices in the Ethernet space or environment though connection β_{de}, as a transfer. Shelving and racking systems, and other displays are located in this Ethernet space. Signals are transferred within the Ethernet space to a local access server, with each store equipped with at least one local access server. The local access server supplies Signal Processing Software with digitized signals from the shelves which are converted to Real-time Inventory Data by the Signal Processing Software. Finally, the Real-time Inventory Data is transferred from the Signal Processing Software to the cloud database through connection β_{ec} via an internal API.

In the layer/shell α_{d}, i.e., Ethernet space, there are two sub-layers/shells i.e., edge layer/shell and fog layer/shell for data transfer from the physical devices in the layer/shell α_{d}. In general, the edge server would first send the data to the fog layer over a localized network to decide whether it is worth sending on to the cloud to reduce the traffic, particularly, for complex information or large field, like images or video, and to avoid the impact on bandwidth and latency. The edge computing and fog computing work for cloud database to store and process relevant data with a significant efficiency through cloud computing. It's necessary to have an edge layer/shell but may not have the fog layer/shell.

In addition, a client layer/shell α_{c} is beyond the cloud layer/shell α_{c}. Both layer/shells are linked through connection β_{cc1} via a communication protocol such as HTTP.

Two APIs, the internal API and the public API, can be represented by concentric circles in the cloud layer/shell. The internal API communicates with the Ethernet layer/shell's Processing Software, while the public API communicates with the client layer/shell.

Requests by client apps and processes are sent to the cloud database via the public API.

Requests to read from and write to the database from the Ethernet layer's Processing Software are sent to the cloud database via the internal API.

Layers/shells αₚ, αₐ, α_{d}, αₑ, α_{c}, and α_{c1} represent perception, analog signals, digital signals, Ethernet processing, the cloud database, and client apps and processes, respectively.

Connections βₚₐ, β_{ad}, β_{de}, β_{ec} and β_{cc1} represent (1) analog signal generation, (2) analog signal-to-digital signal conversion, (3) signal processing and Real-Time Inventory data generation in the Ethernet, (4) data transferred from the Ethernet space to the cloud database, and (5) client apps and processes sending requests for data and services to the cloud database through the public API. These connections are represented from lower to higher levels, respectively.

Multiple layers/shells perform as a quantum structure working from lower to higher levels represented by signals and data, and data qualities. Among them, the cloud database, as the data storage, represents the highest level among all connections; subordinate to this layer is the Ethernet with local server(s) for data creation, operating, and communication. Nodes are basic units for data generation and processing from perception and the analog signals generated. There are six layers/shells and five connections, and three sub-layers/shells in the client layer/shell. The cloud database as data storage communicates to server(s) in the Ethernet layer/shell αₑ through cloud connection β_{ec} and fulfills requests by client apps and processes through the public API.

Perception and connections can be composed of any devices made by biological, organic, chemical, electronic, electrical, thermal, magnetic, acoustic, mechanic or other elements/materials by use of None-AI technology or AI technology such as CNN (Convolutional Neural Network).

The structures can be expressed by mathematical formulas. They are:

$$\begin{matrix}( {α}_{p} + {α}_{a} + {α}_{e} ) = Node ( e - unit ) ; \\ STRU = {ε}_{stru} ( Node , PCB , ECP , PS , F M )\end{matrix}$$

Where, STRU means architectural structure of a device, including
Nodes, PCBs (printing circuit boards), and other elements:
ECP means electrical/electronic component,
PS means Power Supply, and
FM means Firmware.

Software for Networking and Processing in the Ethernet Environment is expressed by the following formula:

SW=Φ_{sw}(ID,SP,EC,FC,CC,APIs,APPs,CMS)
Where,
   ID is defined as an identification number assigned.
   SP is the Software Process for perception detection, conversion, and additional processing of data, and local network and cloud database communications.
   EC is the edge computing.
   FC is the fog computing.
   CC is the cloud computing.
   API is the application programming interface comprising the public API and the internal API.
   APP is an end-user software program residing on a computing device such as a laptop, mobile device, etc.
   CMS is the centralized and cloud-based monitoring system.

Network NT is described as

NT=μₙₜ(ID,Stru,Con,SV,OS,ES)
Where,
   Stru is a Structure built by nodes, PCBs and other elements,
   Con is Connections,
   SV is Servers,
   OS is Operating System,
   PS is Power Supply, and
   ID is Identification.

A centralized and cloud-based real-time inventory monitoring system for store shelving/racking systems built with electronic and electric parts is described below as an embodiment to illustrate the Quantum system.

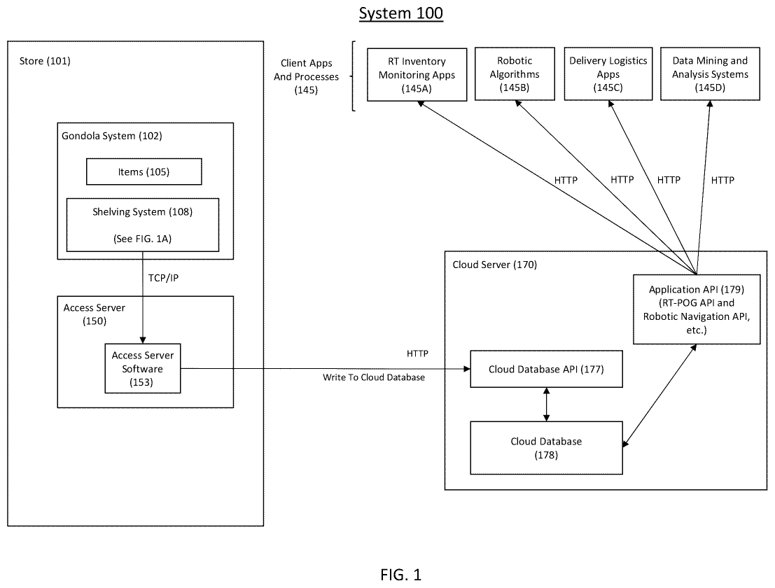

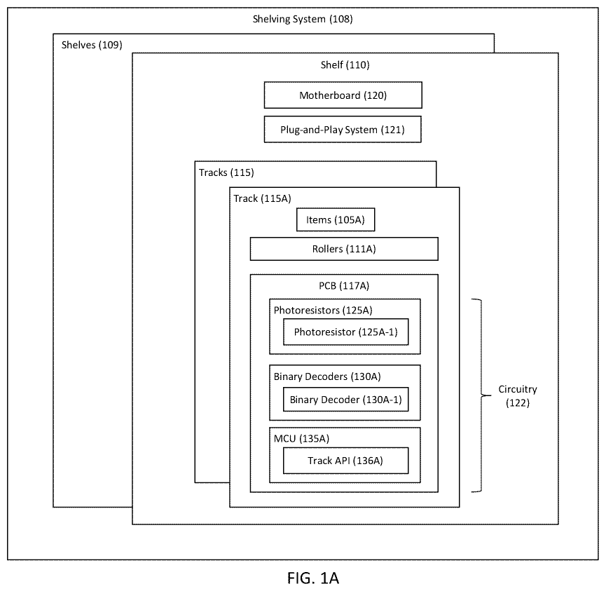

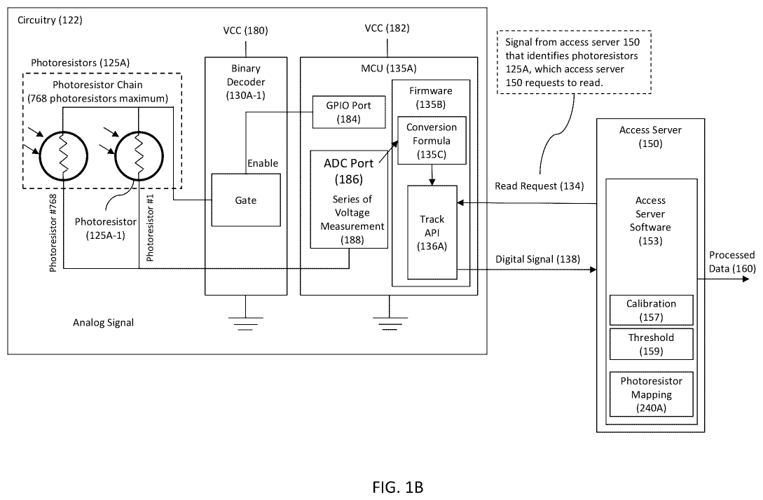

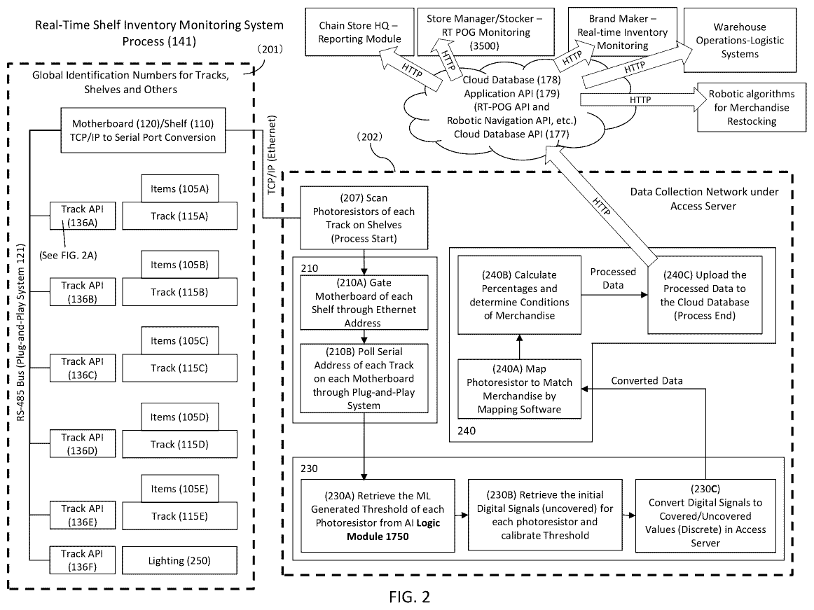

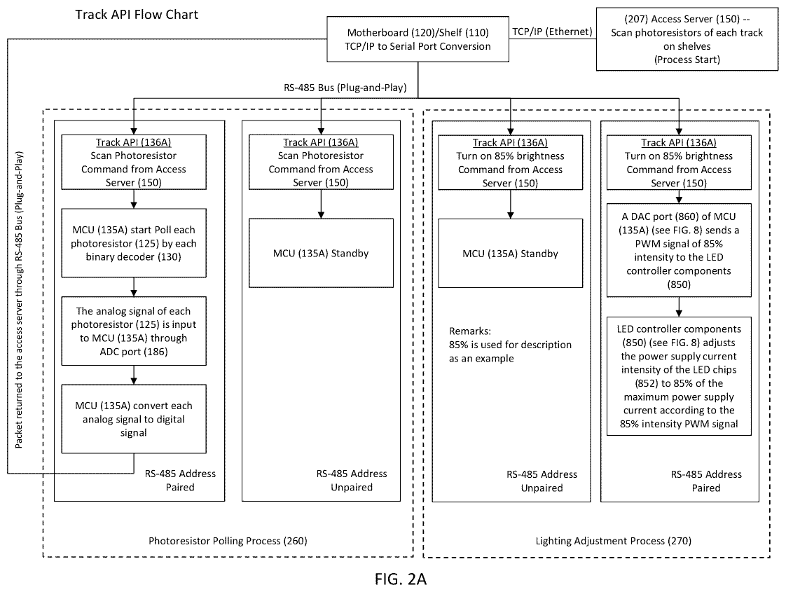

FIGS. 1, 1A, 1B, 2 and 2A are block diagrams that describe the above real-time inventory monitoring system. These figures show the above-mentioned perception, layers/shells and connections.

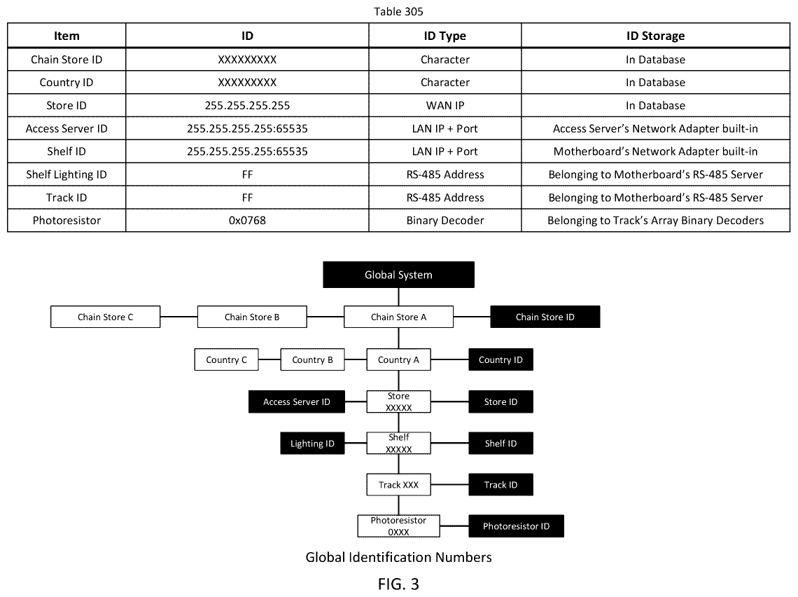

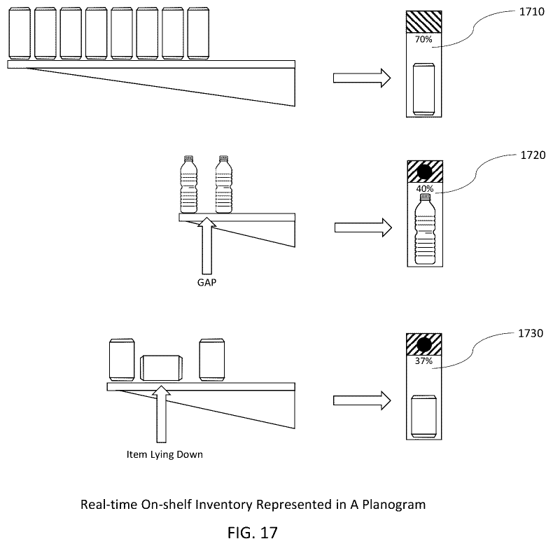

FIGS. 3 to 16 describe the inventory monitoring system of the embodiment in detail. FIGS. 17 to 20 show the results of Real-time inventory, i.e., RT-inventory on shelves.

A planogram (POG) is a diagram or model that indicates placement of retail products (i.e., merchandise), on shelves in order to maximize sales. A POG typically shows products, brands, specifications, weights, prices, advertising items, positions, etc.

A real-time POG (RT-POG) is a POG that shows real-time shelf inventory and stocking/replenishment data and conditions, using the format of a POG. “Real-time”, as used herein, means either instantaneously gathered on-shelf inventory data and conditions, or data and conditions that are no older than a few seconds, minutes or, at most, an hour.

FIG. 1 is a block diagram of a real-time shelf inventory monitoring system, namely system 100 as an embodiment.

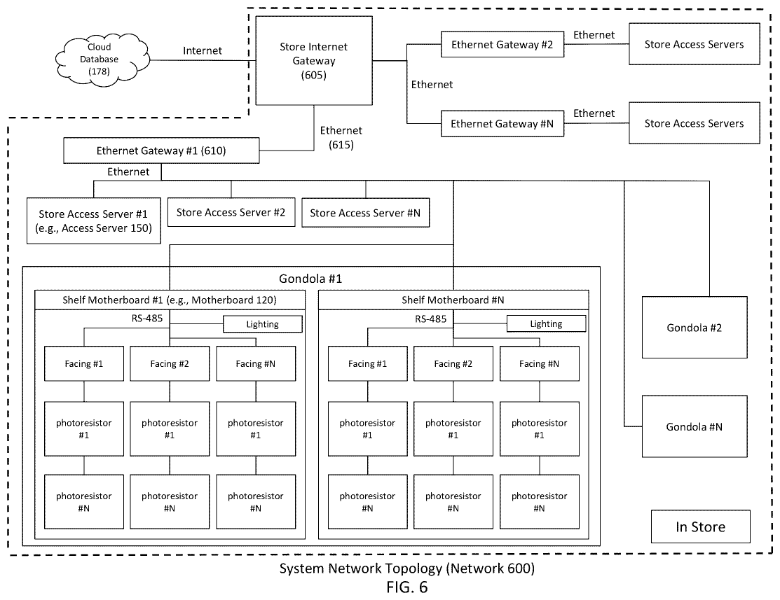

System 100 includes (a) a gondola system 102 and an access server 150 in a store 101, (b) a cloud server 170, (c) multiple client apps and processes 145, and (d) a network system 600 (see FIG. 6).

Store 101 is a retail establishment.

Gondola system 102 is a fixture to display items 105, e.g., merchandise, and includes a shelving component, i.e., shelving system 108.

FIG. 1A is a block diagram of shelving system 108. Components shown in FIGS. 1 and 1A are generalized representations of components described in the present document, and are not drawn to scale, but instead, drawn to show their functional relationships to one another.

Shelving system 108 includes a plurality of shelves 109, a representative one of which is designated as shelf 110.

Shelf 110 includes a motherboard 120, a plug-and-play component, i.e., plug-and-play system 121, and a plurality of tracks 115, a representative one of which is designated as track 115A.

Motherboard 120 is a circuit board that includes circuitry for power management, network management and serial port to Ethernet conversion.

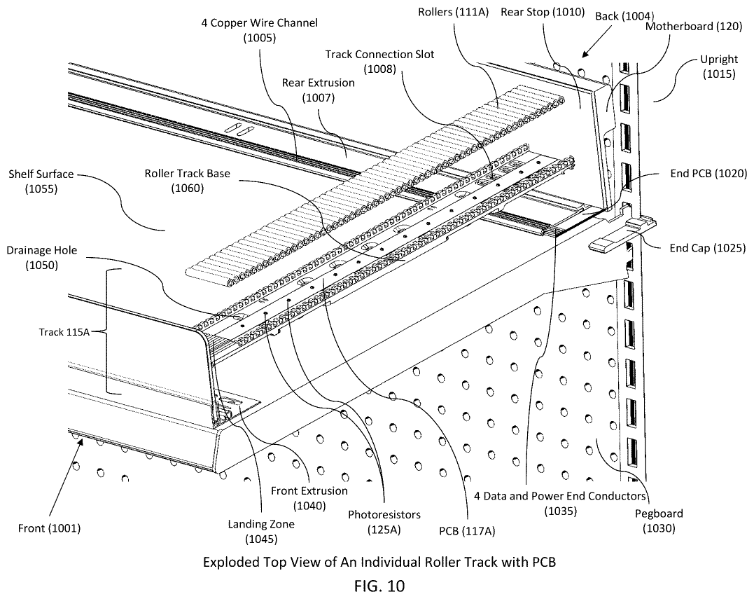

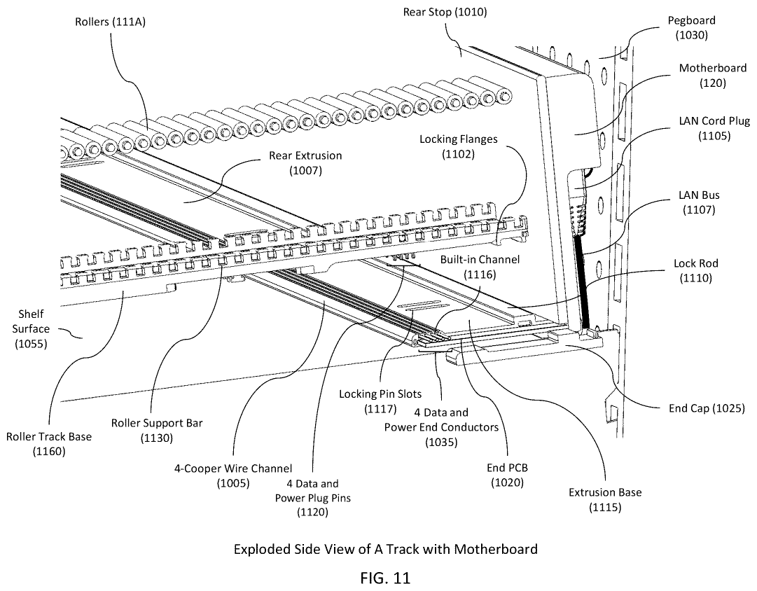

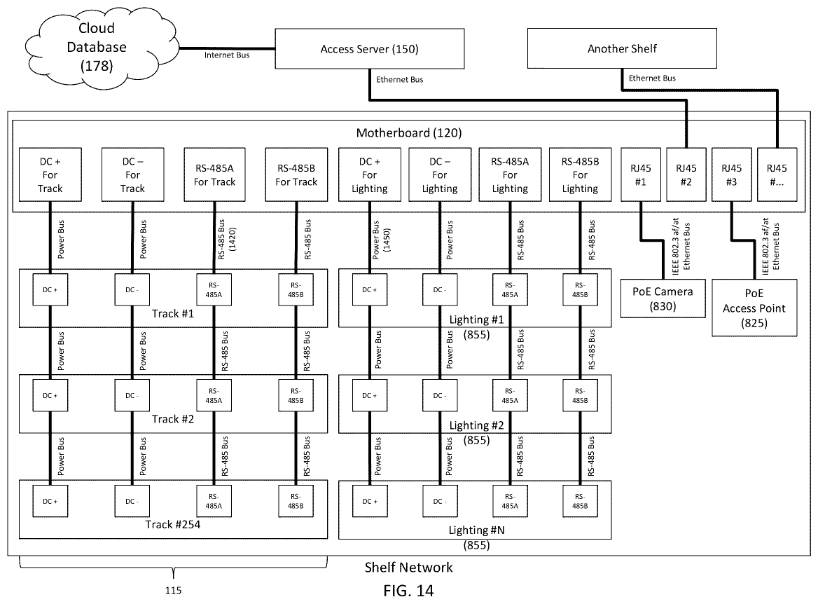

Plug-and-play system 121 is used for non-point-to-point communication for high efficiency. Plug-and play system 121 comprises (1) at least four conductive wire channel, e.g., 4-copper wire channel 1005 (see FIG. 10), (2) track plug pins corresponding to the number of conductive wires, e.g., 4-data and power copper wires 1120 (see FIG. 11), (3) power buses 1450 (see FIG. 14), and (4) a data link based on the connections of N nodes in a multi-point network such as RS-485 buses 1420 (see FIG. 14).

Track 115A includes a plurality of rollers 111A, and a printed circuit board (PCB) 117A.

Rollers 111A are situated on a top surface of track 115A. Rollers 111A are, collectively, a gravity-feed advancement device on which items 105A, i.e., a subset of items 105, are moveably disposed, such that gravity encourages items 105A to move towards a front of shelf 110 so that a person can see and access items 105A. Rollers 111A are configured with a plurality of individual rollers or gliding ribs, such that there is a gap between adjacent rollers or gliding ribs through which light can pass.

PCB 117A includes circuitry 122 that, in turn, includes (a) a plurality of photoresistors 125A, a representative one of which is designated as photoresistor 125A-1, (b) a plurality of binary decoders 130A, a representative one of which is designated as binary decoder 130A-1, and (c) a microcontroller unit (MCU) 135A, which includes a track application program interface (API) 136A.

Photoresistor 125A-1 is a light-sensitive component that has a resistance that varies, over a continuum, based on an amount or intensity of light that is incident on photoresistor 125A-1. For example, as the amount of light increases, the resistance of photoresistor 125A-1 decreases. An output from photoresistor 125A-1 is an analog signal, e.g., a current or a voltage, where a magnitude of the signal is indicative of the amount or intensity of the light that is incident on photoresistor 125A-1. Thus, photoresistor 125A-1 produces electrical signals, such as current or voltage, when exposed to light, and the electrical signal is a linearly varying analog signal. Others of photoresistors 125A operate similarly to photoresistor 125A-1.

A photodiode can be used as an alternative to photoresistor 125A-1. A photodiode is a semiconductor that converts light into electrical current, where the current varies based on the amount or intensity of light that is incident on the photodiode. Photoresistors 125A can be implemented with any light-sensitive component having a characteristic that varies, over a continuum, based on an intensity of light that is incident thereon.

Binary decoders 130A poll and communicate with photoresistors 125A.

MCU 135A communicates with, and controls, binary decoders 130A.

Others of tracks 115 are configured similarly to track 115A.

PCB 117A is situated beneath rollers 111A, and as mentioned above, there is a gap between adjacent rollers 111A through which light can pass. The light is sensed by one or more photoresistors 125A situated beneath the gap, which detect the light and produce an analog signal that is indicative of an intensity of the light, and thus indicative of an area or volume of shelf 110 that is occupied by items 105A on shelf 110, or not occupied by items 105A on shelf 110.

Refer again to FIG. 1.

Access server 150 includes access server software 153.

Cloud server 170 includes a cloud database 178, a cloud database API 177, and application API 179 including RT-POG API and robotic navigation API, etc., accessible to the client apps and processes.

Client apps and processes 145 include, but are not limited to, RT Inventory Monitoring Apps 145A, Robotic Algorithms 145B, Delivery Logistics Apps 145C, and Data Mining and Analysis Systems 145D, running on desktop, mobile, wearable, and specialized devices, or any authorized device capable of accessing application API 179, and processing the received data.

In general, cloud tech is adaptive to very large data volume and very efficient high-speed data transactions such as real-time performance. It also ensures a high level of data normalization which includes lack of data duplication, as well as elimination of data synchronization issues, and allows real-time data access for remote client apps and processes.

Access server 150 serves data to cloud database 178 through cloud database API 177.

Access server software 153 manages processes of access server 150, which include polling the tracks for data, applying a threshold to convert digital signals to covered/uncovered values, mapping photoresistors to match merchandise dimensions, calculating percentages and determining merchandise conditions, and uploading this processed data to cloud database 178.

Cloud server 170 serves data for store 101 to client apps and processes 145. In practice, system 100 can include a plurality of stores configured similarly to store 101, and as such, cloud server 170 will serve data to client apps and processes 145 for the plurality of stores.

FIG. 1B is a schematic diagram of the system of FIG. 1 showing a process from an analog signal produced by a photoresistor, to the processed data.

Shelf 110 holds a quantity of photoresistors 125A equal to N×M, where N is a quantity of photoresistors 125A along a depth of track 115A, and where M is a quantity of tracks 115 along a width of shelf 110. In system 100, N is less than or equal to 768. Thus, photoresistors 125A are situated on PCB 117A with the maximum number of photoresistors 125A for track 115A equal to 768, although in practice, that number can change dependent on design. The number of photoresistors 125A can be more than 768 if it is necessary.

As mentioned above, an output from photoresistor 125A-1 is an analog signal, e.g., a voltage, for which the magnitude of the signal is indicative of the amount or intensity of the incident light on photoresistor 125A-1. Meanwhile, the voltage common collector (VCC) 182 of MCU 135A is the voltage of power supplied to the MCU 135A and is used to compare with the voltage of photoresistor 125A-1 as a reference voltage. The VCC 180 is the voltage of power supplied to the binary decoder 130A-1. Photoresistors 125A-1 is affected by incident light, and results in an output voltage drop. The relationship between light intensity and output of voltage is linear. The power supply voltages of VCC 180 and VCC 182 can be either +3.3V, +5V or others, but the magnitude of power supply voltage of VCC 180 and VCC 182 are the same.

The analog signals produced by photoresistors 125A are converted to digital signals by a conversion formula 135C for data processing through a polling process by binary decoder 130A-1 under control of MCU 135A.

Components of MCU 135A include a general-purpose input/output (GPIO) port 184 and an analog-to-digital converter (ADC) port 186. In addition, MCU 135A includes track API 136A.

The input to ADC port 186 is a series of voltage measurement values 188 (analog), and the measurement range of MCU 135A output is converted from 0-VCC (analog) to 1-4095 (digital) through conversion formula 135C. Thus, the output of track API 136A is a digital signal 138.

Track API 136A works upon receiving a read request 134, or order, from access server software 153, and responds to access server 150 with digital signal 138.

Digital signals are polled and managed by access server software 153, and further converted to processed data 160 after going through a calibration process 157, a threshold process 159, and a photoresistor mapping process 240A.

In practice, store 101 will include a plurality of gondolas configured similarly to gondola system 102, and each gondola will include a plurality of shelves configured similarly to shelf 110, and each of those shelves will include a plurality of tracks configured similarly to track 115A, with rollers, PCBs, photoresistors, binary decoders and MCUs. Moreover, an extended embodiment of system 100 will encompass a plurality of stores configured similarly to store 101.

FIG. 2 is a flowchart of a real-time shelf inventory monitoring system process, namely process 141. In order to describe process 141, FIG. 2 shows motherboard 120, shelf 110, track API 136A, items 105A, and track 115A.

In FIG. 2, there are two blocks. One block, namely block 201, represents shelf 110, and the other block, namely process 202, represents operations in access server 150.

FIG. 2 also shows (a) track APIs 136B, 136C, 136D and 136E, which are operationally similar to track API 136A, (b) tracks 115B, 115C, 115D and 115E, which are operationally similar to track 115A, and (c) items 105B, 105C, 105D and 105E, which are subsets of items 105. APIs 136B through 136E are associated with tracks 115B through 115E, respectively, and items 105B, 105C, 105D and 105E are moveably disposed on tracks 115B, 115C, 115D and 115E, respectively. In addition, block 201 shows lighting 250 managed by track API 136F for many important applications including environment lighting adjustment, indicator as an alert when merchandise inventory on shelf is below alert level, lighting for cameras to recognize barcodes, application for sterilization and others.

Process 202 outlines a process to convert analog signals generated by photoresistors installed on tracks 115 to digital data in access server 150 as a start 207 of process 202 for description purpose, and furthermore, convert data to covered/uncovered values, map photoresistors to merchandise items, calculate percentages and determine conditions of merchandising which is then uploaded to cloud database 178. This data can then be accessed through application API 179 (which includes RT-POG API and Robotic Navigation API, etc.) by a client app or process such as RT-POG.

In system 100, a unique global identification number is assigned to each:
(a) photoresistor, e.g., photoresistor 125A-1;
(b) group of photoresistors, e.g., photoresistors 125A;
(c) track, e.g., track 115A;
(d) motherboard, e.g., motherboard 120;
(e) plug-and-play system, e.g., plug-and-play system 121; and
(f) shelf, e.g., shelf 110.

Regarding block 201, as mentioned above, shelf 110 includes a plurality of tracks 115, and on track 115A, photoresistors 125A are installed on PCB 117A. Items 105A, i.e., a subset of items 105, are disposed on track 115A.

On track 115A, there is a gap between two adjacent rollers 111A through which light can pass and be sensed by one or more of photoresistors 125A that are situated directly beneath the gap, generating an analog signal. Tracks 115B, 115C, 115D and 115E are similarly configured with rollers and photoresistors.

Track APIs 136A, 136B, 136C, 136D and 136E manage signals and data communications for both receiving and responding among various components of tracks 115A, 115B, 115C, 115D and 115E, respectively, and cloud server 170.

Digital signals released from MCU 135A under management of track APIs 136A, 136B, 136C, 136D and 136E are transferred to motherboard 120 through an RS-485 Bus by use of plug-and-play system 121.

Motherboard 120 converts digital signals delivered through the RS-485 Bus to Ethernet through which the TCP/IP (Ethernet) can be used for communication between motherboard 120 and access server 150. In addition, motherboard 120 has a 4-port function of network POE switch.

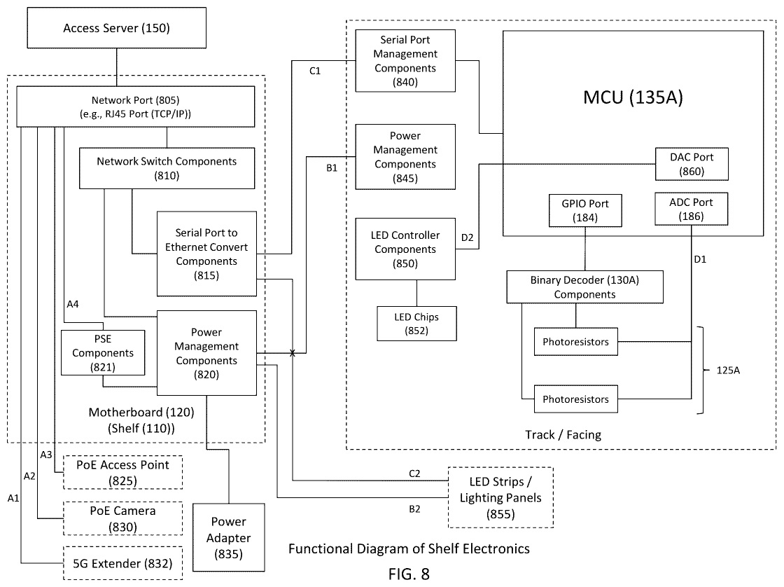

FIG. 8 shows that a four-network port 805 can be designed: one each for input and output, and two for other applications such for a Power Over Ethernet (POE) Access Point (AP) 825, a PoE Camera 830 and/or a 5G extender (832). Every shelf, e.g., shelf 110, has one motherboard, e.g., motherboard 120. If there are 6 shelves per gondola, there are 12 network ports 805 for input and output, and 12 other network ports 805 for multiple applications.

Referring again to FIG. 2, process 202 is a process in access server 150 starting from the photoresistor scanning of each track 115 on shelf 110 through a track API, e.g., scanning photoresistors 125A on track 115A through track API 136A, access server software 153 mapping, conversion, and formatting processes 240A and 240B, and uploading process 240C, to cloud database 178 through Hypertext Transfer Protocol (HTTP).

In access server 150, there is an initial process 207, and three process blocks, namely process blocks 210, 230 and 240.

Process 207 initiates scanning of photoresistors of each track on the shelves, e.g., scanning of photoresistors 125A on track 115A.

Process block 210 performs a polling of a track API for each track, e.g., polling of track API 136A for track 115A. Each Track API is under the control of its corresponding MCU 135, e.g., track API 136A is under control of MCU 135A.

Process block 230 includes three operations, namely:
operation 230A, retrieve the threshold generated by machine learning (ML);
operation 230B, retrieve the initial values of photoresistors and adjust threshold; and
operation 230C, convert data from digital signals to discrete covered/uncovered values.

Process block 240 performs:
operation 240A, mapping of photoresistor to match merchandise;
operation 240B, calculating percentages and determining conditions of merchandise; and
operation 240C, uploading, to cloud database 178 through cloud database API 177, data processed by operations 240A and 240B.

Process blocks 210, 230 and 240 are components of a data collection network under access server 150.

Finally, cloud database 178 connects all client apps and processes through application API 179 (which includes RT-POG API and Robotic Navigation API, etc.) for use by chain store headquarters (HQs), brand makers, warehouses, and robots, through HTTP.

In particular, the POG Monitoring 3500, shown near the top/center of FIG. 2, is a client app used by a Store Manager/Stocker.

FIG. 2A is a flowchart of a processes performed by track API 136A when polled by access server 150.

FIG. 2A shows two processes handled by track APIs, e.g., track API 136A, namely a photoresistor polling process 260, and a lighting adjustment process 270. Processes 260 and 270 are handled by track API 136A during execution of process block 210 within access server 150.

Photoresistor polling process 260 measures the magnitude of the analog signal as it is affected by light intensity striking the photoresistors 125A on track 115A, converts the analog signal to a digital signal and sends the digital signal to access server 150 via motherboard 120. On track 115A, these operations are controlled by MCU 135A.

Lighting adjustment process 270 adjusts light to a certain level of brightness, say 85% of maximum level. Similar to polling process 260, there are “Paired” states and “Unpaired” states because the LED light for a track 115 A is done through lighting on the shelf 110 above the track 115A, and track(s) 115 and the lighting from shelf 110 are “paired” together in the database.

For both photoresistor polling process 260 and lighting adjustment process 270, an RS-485 Bus for plug-and-play and TCP/IP for Ethernet are used to communicate to the related client apps and processes. Additionally, for both processes 260 and 270, there is both an “RS-485 Address Paired” and an “RS-485 Address Unpaired” version of the process.

### Summary of FIGS. 2 and 2A

FIG. 2 and FIG. 2A describe process 141, i.e., the real-time shelf inventory monitoring system process.

Innovations in FIGS. 2 and 2A include:
(a) data collection network;
(b) plug-and-play system;
(c) photoresistor polling by binary decoder under the control of MCU;
(d) threshold calculation by initial values and machine learning (“ML”);
(e) photoresistor mapping to match merchandise;
(f) processing of data involving the calculation of merchandise percentages and conditions of merchandise, which can be accessed to create many applications and visualization including, but not limited to, inventory report over time for tracks, RT-POG for inventory control, delivery logistics, robotic operations, and others;
(g) format of RT-POG;
(h) access server software 153; and
(i) in general, a shelf is workable for power supply and data communication process in any place such as a store, a warehouse or an office equipped with Ethernet.

Each of access server 150 and cloud server 170 can be implemented on an apparatus that includes a processor and a memory. A processor is an electronic device configured of logic circuitry that responds to and executes instructions. A memory is a tangible, non-transitory, computer-readable storage device encoded with a computer program. In this regard, the memory stores data and instructions, i.e., program code, that are readable and executable by a processor for controlling the operation of the processor. The memory may be implemented in random access memory (RAM), a hard drive, a read only memory (ROM), or a combination thereof. The memory in access server 150 stores program modules for controlling the processor in access server 150 to perform operations on behalf of access server 150. The memory in cloud server 170 stores program modules for controlling the processor in cloud server 170 to perform operations on behalf of cloud server 170.

The term “module” is used herein to denote a functional operation that may be embodied either as a stand-alone component or as an integrated configuration of a plurality of subordinate components. Thus, a program module may be implemented as a single module or as a plurality of modules that operate in cooperation with one another. Moreover, program modules may be implemented in software, hardware, e.g., electronic circuitry, firmware, or a combination thereof.

Program modules may also be configured on a tangible, non-transitory external storage device for subsequent loading into memories of access server 150 and cloud server 170. Examples of such an external storage device include (a) a compact disk, (b) a magnetic tape, (c) a read only memory, (d) an optical storage medium, (e) a hard drive, (f) a memory unit consisting of multiple parallel hard drives, (g) a universal serial bus (USB) flash drive, (h) a random access memory, and (i) an electronic storage device coupled, via a network, to access server 150 and cloud server 170.

Although each of access server 150 and cloud server 170 is represented herein as a standalone device, they are not limited to such, but instead can be coupled to other devices in a distributed processing system.

Also, although cloud database 178 is represented herein as a standalone component, it is not limited to such, but instead can be implemented in a plurality of storage devices in a distributed database system.

Data communications between access server 150, cloud server 170, and client apps and processes 145 are conducted over a network that may be a private network or a public network, and may include any or all of (a) a personal area network, e.g., covering a room, (b) a local area network or a wireless local area network, e.g., covering a building, (c) a campus area network, e.g., covering a campus, (d) a metropolitan area network, e.g., covering a city, (e) a wide area network, e.g., covering an area that links across metropolitan, regional, or national boundaries, (f) the Internet, (g) a telephone network, or a wireless communication network (e.g., Bluetooth, etc.). Long term evolution (LTE) is a standard for wireless broadband communication for mobile devices and data terminals. 5G is a successor to LTE. Communications are conducted via the network by way of electronic signals and optical signals that propagate through a wire or optical fiber or are transmitted and received wirelessly.

As mentioned above, a POG is a diagram or model that indicates placement of retail products, i.e., merchandise, on shelves in order to maximize sales, and typically shows products, brands, specifications, weights, prices, advertising items, positions, etc. Additionally, a POG typically includes three sections: the first is a colorful rendering showing products with position numbers; the second is a layout presenting the product positions with position numbers in black and white; and the third is a product specification tables listing store ID #, UPC, weight, sizes, name, brand, pack, and others of each product.

Referring again to FIG. 2, the following several paragraphs summarize operations performed by process 202.

Process 202 includes or employs features such as:
(a) a data collection network;
(b) a data operation system;
(c) a plug-and-play system;
(d) photoresistor polling and retrieval by binary decoder 130A-1 under the control of MCU 135A;
(e) threshold calculation by initial values and machine learning (ML);
(f) photoresistor mapping to match merchandise; and
(g) an RT-POG, showing merchandise percentages, conditions, and time reports of items 105, e.g., merchandise, on an individual track, e.g., track 115A.

As mentioned above, there are three process blocks within the data collection network that operates under access server 150. They are:
process block 210: motherboard gating and track polling;
process block 230: converting pre-calibration data to covered/uncovered values; and
process block 240: mapping photoresistors to match merchandise, calculating percentages, determining conditions of merchandise, and uploading the processed data to cloud database 178.

Process 202 commences with operation 207. Access server 150—Scan photoresistors of each track on shelves.

Operation 210A. Access server 150—Gate motherboard of each shelf through Ethernet address.

Operation 210B. Access server 150—Poll track of each serial address of shelf motherboard through plug-and-play system.

Operation 230A. Access server 150—Retrieve the ML generated threshold of each photoresistor.

Operation 230B. Retrieve the initial values (uncovered digital voltage value) for each photoresistor and calibrate threshold.

Operation 230C. Convert digital signals to covered/uncovered values (discrete) in access server.

Operation 240A. Map photoresistor to match merchandise by mapping software.

Operation 240B. Calculate percentages and determine conditions of merchandise.

Operation 240C. Access server 150—Upload processed data to cloud database 178.

End process 240.

Process 202 populates cloud database 178 with formatted data for the following use cases:
(a) Reporting Module used by chain store HQ;
(b) Real-time inventory monitoring based on a planogram (RT POG) used by a store manager and/or stockers;
(c) Real-time inventory monitoring based on brand across stores used by a brand maker;
(d) Logistics systems used by warehouse operations; and
(e) Robotic algorithms used for merchandise restocking.

Each photoresistor, track, shelf or component such as MCU 135A, binary-decoder 130A-1, and PCB 117A, is assigned a unique global identification (ID) number.

FIG. 3 is a table, namely Table 305, and a flowchart of Global Identification Numbers indicating a global retail system, which is composed of multiple layers: chain stores, countries, shelves, tracks, and photoresistors.

Certain communications in system 100, e.g., Plug-and-Play system 121, are conducted in accordance with RS-485, which is a standard defining the electrical characteristics of drivers and receivers for use in serial communications systems.

Features of this global retail system include a unique cloud-based global ID for each element, from chain stores to every photoresistor, at multiple levels, in real-time; and governed by cloud-based communication between this global system and each unique element.

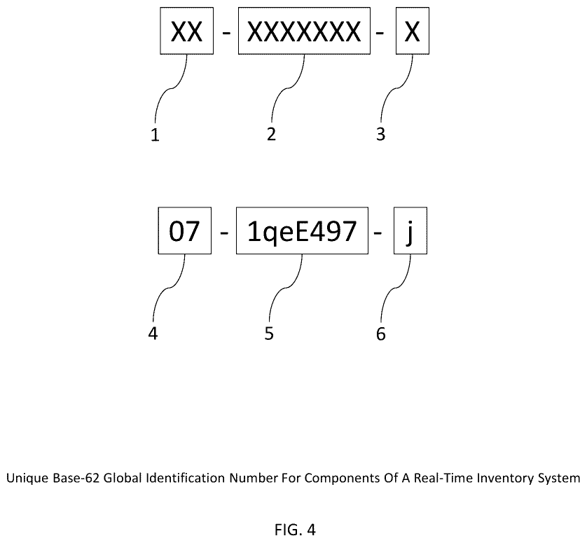

FIG. 4 illustrates a unique Base-62 global identification number, which will be referred to as the “unique global ID” within this document, for components of a real-time inventory system. The unique global ID is a 10-character string representing a base-62 number that uniquely identifies each component in cloud database 178. The unique Global identifies the components quickly and allows for easy retrieval from cloud database 178.

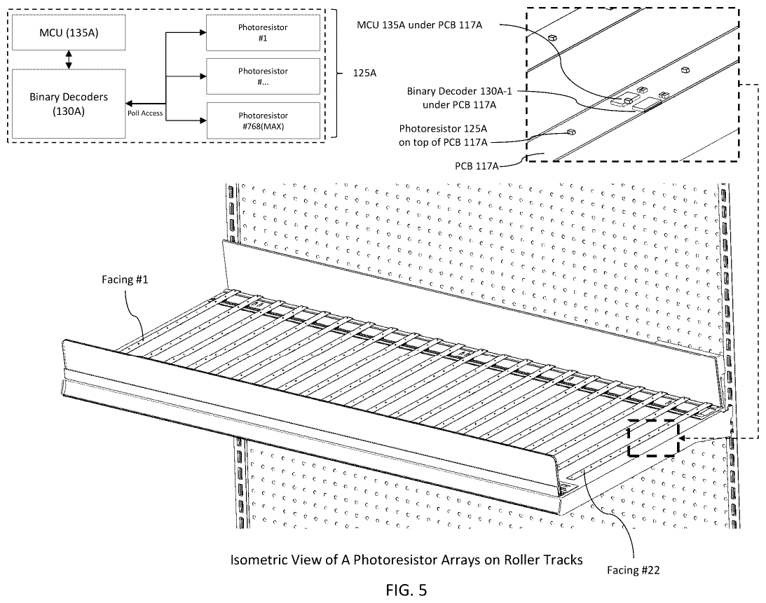

The basic logical components in cloud database 178 are stores, display fixtures, shelves, facings and photoresistors. A facing (see FIG. 5, Facing #22) is a row of merchandise items 105 lined up on a track 115A so that the first merchandise item 105 is visible to the customer at the front 1001 shown in FIG. 10 of shelf 110, with all other items 105 in the facing aligned behind it and extending to the back 1004 shown in FIG. 10 of the shelf 110. All these components have a unique Global ID. Additionally, networking-related components such as routers, motherboards, tracks and other equipment pieces are assigned a unique Global ID. Besides these above-mentioned items, other entities and components can have a unique Global ID. For example, cameras, robots, restocking trays, warehouses, regions, suppliers, customers, etc., can have Global IDs.

The unique global ID has 10 characters. The unique global ID uses base-62 by using all numeric characters 0-9, all 26 lowercase letters and all 26 uppercase letters of the English alphabet. The present format of the unique global ID and the use of base-62 allows 3,844 different components, each with a possible 3.5 trillion unique global IDs to be designated, along with a checksum digit, all within a 10-digit ID.

### System Network Topology

FIG. 5 is an isometric view of a photoresistor array, e.g., photoresistors 125A, on tracks, e.g., tracks 115, on a shelf, e.g., shelf 110.

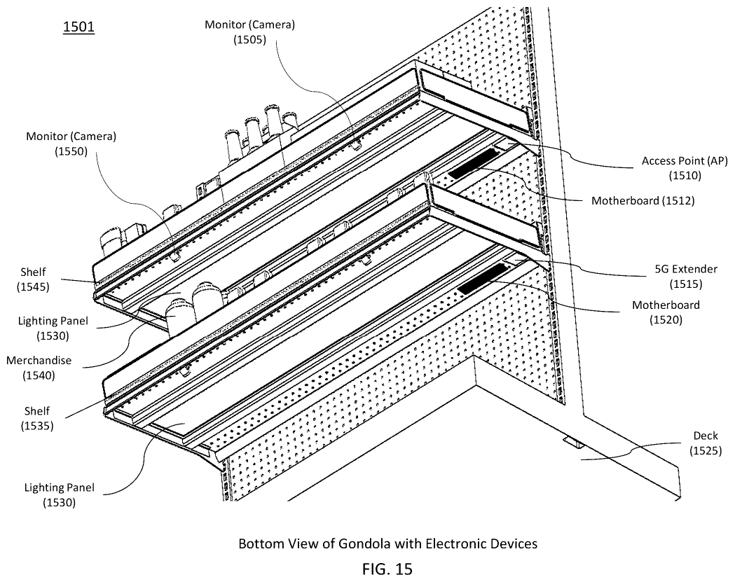

The left-most most facing (or track) is designated Facing #1 and the right-most facing (or track) is Facing #22. All facings are installed in a row from Facing #1 to Facing #22. Along the shelf width, the selected maximum number of facing addresses and lighting devices addresses is 255. Lighting device include, but are not limited to, LED on the lighting panel 1530 in FIG. 15. 256 is the maximum number of current standard chip resolution. Among 256, one number is assigned to FF. The rest is up to 255. The selected maximum number for a photoresistor array installed on the length of a PCB, e.g., PCB 117A, is 768.

FIG. 5 shows the physical structure of PCB 117A. Photoresistors 125A are placed on the top surface of PCB 117A while binary decoder 130A-1 and MCU 135A are on the bottom of PCB 117A.

In addition, FIG. 5 shows a flowchart describing binary decoders 130A performing as a polling access to communicate cyclically with all photoresistors 125A one by one. MCU 135A controls communication with binary decoders 130A for the polling process.

FIG. 6 is a block diagram of a system network topology in which facing IDs along a shelf width, and the photoresistor array IDs, form an ID system in a two-dimensional x-y plane, and further, form a system network. This system network works together with an RT-POG and provides an independent communication ID address as well as an actual physical address for each element. By using a mapping technique, one can find any merchandise's sensing position on a shelf.

The resolution of the merchandise on a shelf depends on the density of photoresistors 125A along width and depth, as well as the software capability.

Each photoresistor, e.g., photoresistor 125A-1, on track 115A is linked to motherboard 120 of shelf 110 by RS-485, then motherboard 120 is linked to access server 150 through Ethernet, and access server 150 is linked to cloud database API 177 through HTTP. Operation from cloud database 178 to photoresistor, e.g., photoresistor 125A-1, is described here.

First, cloud database API 177 is linked to a store internet gateway 605 (router) (see FIG. 6) by the internet through HTTP. A router, as a device, communicates between the internet and devices in this system network, such as motherboard 120.

Second, and referring again to FIG. 6, store internet gateway 605 (router) and an Ethernet gateway 610 (router) are linked by Ethernet, e.g., Ethernet 615. The number of Ethernet gateway (router) can range from 1 to 253. These Ethernet gateways (routers) are isolated from each other by different IP range segments and netmasks to reduce network traffic and broadcast storm risks, though a virtual local area network (VLAN) could be another choice. Under the consideration of risks, we select subnets or netmasks where multiple routes are used to build the system network in a store.

Third, the IP and netmask of each access server, e.g., access server 150, and multiple shelf motherboards, e.g., motherboard 120, are set in the same IP range. The quantity of the shelf motherboard for each access server depends on the process speed of this access server. With the development of hardware and software, more and more shelf motherboards can be managed, but ultimately, in practice, may be limited, for example, to a quantity of 65,535, the total capacity of Ethernet IP. In the case of subnet mask or netmask, one route works for 253 shelves.

Fourth, a gondola does not have an IP. Gondolas are numbered by store as gondola ID recorded in cloud database 178.

Fifth, each access server, e.g., access server 150, communicates with cloud database 178 directly. Each access server, e.g., access server 150, is assigned an ID in cloud database 178. In general, communication between access server software 153 of the access server 150 of a store 101 and cloud database API 177 is linked by HTTP.

Sixth, the shelf motherboard, e.g., motherboard 120, is linked to each facing or each lighting panel 1530 (see FIG. 15) including devices and placed on the bottom of shelf 110 by an RS-485 bus (Modbus protocol), and works as an RS-485 server, for which each facing or each lighting panel is an RS-485 client. Either each facing or each lighting panel uses a hexadecimal RS-485 address as the facing or lighting ID, and the total number of RS-485 clients is 254 (01-FE).

Seventh, the MCU, e.g., MCU 135A, on each PCB, e.g., PCB 117A, controls the multi-level binary decoders, e.g., binary decoders 130A, to switch high level and low level of the circuit for on-off switching of each photoresistor, in turn. The selected maximum quantity of photoresistors 125A on PCB 117A, and therefor on track 115A, is 768. Each photoresistor is assigned an ID from 0x0000.

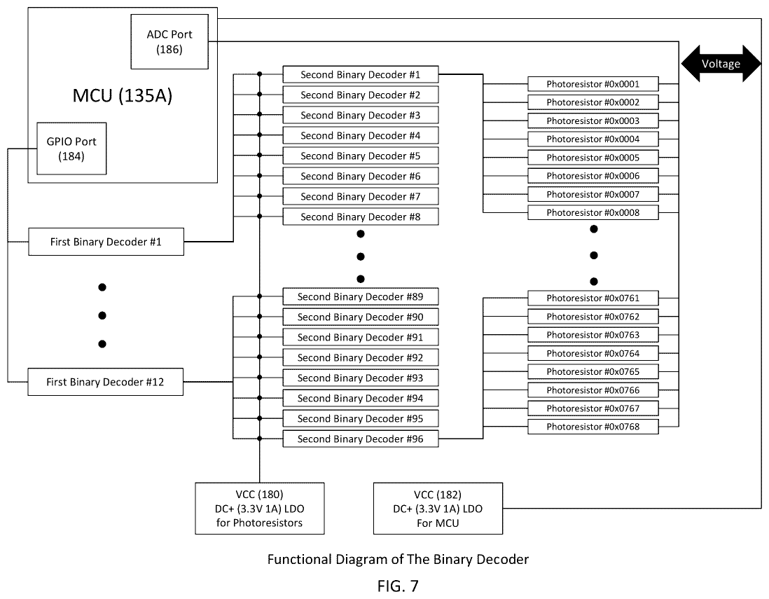

FIG. 7 is a block diagram of a binary decoder, e.g., binary decoder 130A-1, showing the working process of the binary decoder. In FIG. 7, there are twelve first binary decoders, namely First Binary Decoders #1, #2, #3 to #12. Each first binary decoder interfaces with eight second binary decoders and each secondary binary decoder interfaces with eight photoresistors, e.g., eight of photoresistors 125A. When GPIO port 184 polls each binary decoder, each photoresistor under this polled binary decoder is gated and linked to ADC port 186, and all analog signals produced by photoresistors 125A are converted to digital signals through ADC port 186, which translates analog electrical signals for data processing purpose controlled by MCU 135A. Both of ADC port 186 and GPIO port 184 are parts of MCU 135A. Either analog signals produced by photoresistors or digital signals are based on voltage.

Let us recall the global ID system of FIG. 3, which shows the elements of the lowest level, i.e., photoresistors 125A, placed on PCB 117A of a given track, e.g., track 115A, which sense the intensity change of light received. When a track, e.g., track 115A, is inserted onto both front and rear track extrusions, 4 pins of the track are linked to 4 electrically conductive, e.g., copper, wires, and data are conducted to the motherboard, e.g., motherboard 120, immediately (see FIG. 10).

Furthermore, initial values of photoresistors 125A are recorded when there is no merchandise on the track (see the illustration on the left side of FIG. 15). Orders issued by access server 150 are transmitted to the track of a given ID through the TCP/IP and RS-485 communication protocols.

The track, e.g., track 115A, sequentially records the present resistance (or voltage) value of each photoresistor, e.g., each of photoresistors 125A, through ADC port 186 and is converted into a corresponding magnitude in a range scaled by 4095 (i.e., 0 to 4095) from 0 to VCC as a series of voltage measurement 188, and then the data is sent back to access server 150 as the digital signals of the photoresistors on the track. The track API process is completed at that point.

The data conversion process of photoresistors 125A is described here. The gap between two rollers, e.g., adjacent rollers that are parts of rollers 111A, provides sufficient illumination for photoresistors 125A beneath track 115A, and each of photoresistors 125A generates a corresponding linear change in its resistance according to the received light flux. Photoresistors 125A are connected in series with a 3.3V/1 A DC circuit VCC 180 causing a voltage/current change along with the light flux. The resistance value becomes lowest, and the voltage goes highest, when the light flux received is maximum. Contrarily, the resistance value becomes highest when a photoresistor, e.g., photoresistor 125A-1, is blocked by merchandise, e.g., items 105, and DC voltage drops down accordingly. In short, in response to the magnitude change of incoming light flux, a DC electrical, i.e., analog, signal occurs.

FIG. 7 shows that MCU 135A controls binary decoders 130A to switch addresses of photoresistors 125A in a loop process (e.g., to photoresistor #0x0765, while measuring the voltage difference between the DC current of photoresistor #0x0765 and the standard DC of low dropout (LDO), e.g., DC+ (3.3V 1 A) LDO, VCC 182). According to the acquisition accuracy, such as in 12-bit resolution, of ADC port 186, MCU 135A divides 3.3V, the maximum voltage strength, by 4095 equally, i.e., a range of 1 to 4095, and records the above-mentioned relative voltage difference, i.e., photoresistor #0x0765, during the polling process. A series of voltage measurement 188 of all photoresistors 125A (in comparison with a DC+ (3.3V 1 A) LDO for MCU, VCC 182) are recorded during the polling process.

Photoresistors 125A are organized by multiple levels of binary decoders 130A controlled by MCU135A. A quantity of the multiple levels is used to adapt a quantity of photoresistors 125A. The second level of binary decoders, e.g., #1 to #8 of level 2, are linked by one of the first binary decoders (level 1). If necessary, a third level of binary decoders can be built as level 3 to link to the level 2. Similarly, level 4, level 5 and more levels can be built. FIG. 7 shows that every binary decoder of level 1 links eight binary decoders of level 2, and every binary decoder of the lowest level links eight photoresistors. This structure can be extended to more photoresistors by use of the multiple level links.

FIG. 8 is a block diagram of electronics on shelf 110, including two functional blocks, namely, motherboard and tracks.

### Motherboard

Motherboard 120 represents shelf 110 since there is only one motherboard per shelf. A power adapter 835 supplies power to motherboard 120. Motherboard 120 maintains Ethernet communication with access server 150.

An access point (AP) is a networking hardware device that allows wireless devices to connect to a wired network. The AP connects directly to a local area network (LAN), e.g., Ethernet, and then provides wireless connections to other devices using wireless LAN technology.

Power over Ethernet (POE) is a technique for providing electrical power to a device over Ethernet data cables. Motherboard 120 provides power and communication links for tracks 115, a PoE camera 830 and a PoE AP 825.

A network port 805, e.g., an RJ45 port (TCP/IP), is an 8-pin/8-position plug or jack that is commonly used to connect computers onto Ethernet-based local area networks. Network port 805 may be referred to as a Transmission Control Protocol/Internet Protocol (TCP/IP) port or an Ethernet port. Built-in network switch components 810 of motherboard 120 expand the Ethernet into multiple RJ45 ports, and PoE camera 830 and PoE AP 825 use standard RJ45 ports.

Serial port to Ethernet components 815 built into motherboard 120 serve as a TCP server, and one of the ports of network switch components 810 is forwarded to the RS-485 bus and actDs as a serial server, providing Ethernet links for tracks 115 and lighting through conductive tracks.

Built-in power management components 820 of motherboard 120 are used as the power management of the entire shelf 110. It works for the multi-layer conversion of the DC transmitted from power adapter 835, respectively. In FIG. 8:
(a) line A4 provides PSE (power sourcing equipment) power supply control for RJ45 port 805 in accordance with 802.3af/at protocol; lines A1, A2 and A3 link the 5G/6G Extender 832, PoE Camera 830 and PoE Access Point 825, respectively;
(b) line B1 connects power management components 845 of track 115A and power management components 820 of motherboard 120 through the conductive track; and line B2 provides DC power supply for light emitting diode (LED) strips/lighting panels 855 on the shelf bottom through cable; and
(c) line C1 connects serial port to ethernet convert components 815 of motherboard 120 and serial port management components 840 of track 115A; and line C2 provides RS-485 communication for light emitting diode (LED) strips/lighting panels 855 on the shelf bottom through cable.

### Tracks

A built-in serial port management component 840 of track 115A is used as the serial client of the RS-485 bus, which is connected to MCU 135A.

Built-in power management components 845 of track 115A receive power from motherboard 120 via the line Bland power all electronic components on track 115A.

As the core component, MCU 135A does the following:
A: records the Facing ID of track 115A;
B: controls the pulse-width modulation (PWM) of a LED controller 850 working with built-in LED chips 852 as merchandise inventory indicators through a digital-to-analog converter (DAC) port 860 to control the light brightness of track 115A via the line D2;
C: controls binary decoders 130A through GPIO port 184 to manage the address decoding of 1-768 photoresistors 125A via the line D1; and
D: processes polling via the line D1 through the following steps: (i) ADC port 186 receives and measures a voltage signal from one of 1-768 photoresistors 125A as an input to ADC port 186; (ii) converts the said voltage signal to digital signal via ADC, and (iii) polls other voltage signals.

LED chips 852 work for an alert on the inventory percentage (of a given track) equal to or lower than an alert level, e.g., 20%.

### Access Server Software

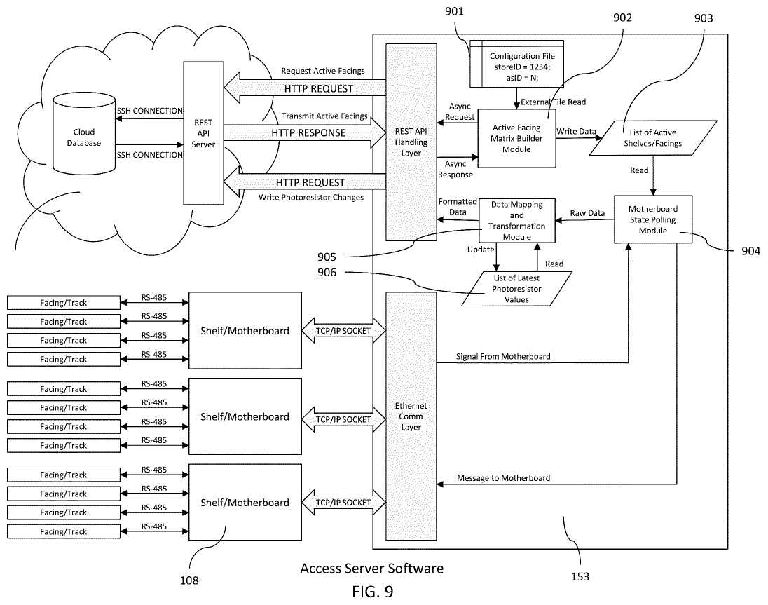

FIG. 9 is a block diagram of access server software 153 and which communicates data signals from the facings/tracks to cloud database 178. FIG. 9 shows an overview of the concept of the software for access server 150, its basic internal processes, and the software's connection to signals from the installed and activated motherboards, e.g., motherboard 120, on-site, and cloud database 178, online.

Access server 150 is a physical computer or other device whose function is to poll the states of all or a subset of all active motherboards, e.g., motherboard 120, in a single store, e.g., store 101, detect changes in the state of any tracks on the motherboard regarding changes to photoresistor states, process and transform those changes to meaningful on-shelf inventory data, and write those changes to cloud database 178. A store can have one or several access servers, such as access server 150, depending on the number of motherboards active in the store. Each store has a unique ID throughout cloud database 178, and each access server has an Active Server ID (asID) unique for that store.

When access server software 153 is activated, an Active Facing Matrix Builder Module 902 is initiated. Active Facing Matrix Builder Module 902 cyclically retrieves a dataset of shelves, facings, and the products in those facings from cloud database 178 that have active motherboards and facings/photoresistor chains registered in cloud database 178. A photoresistor chain is defined as the collection of photoresistors in a track. The scope of the dataset is limited to shelves and facings linked to the store and the asID (Active Server ID) specified in a Configuration File 901. Active Facing Matrix Building Module 902 is responsible for updating an internal List of Active Shelves/Facings 906 used by a Motherboard State Polling Module 904.

Motherboard State Polling Module 904 continuously polls a collection of Shelves/Motherboards-Facings/Photoresistor Chains specified in Internal List of Active Shelves/Facings 903. Shelf/Motherboard 110/120 refers to the pairing of a physical shelf 110 with a motherboard 120. All active shelves 110 have a single motherboard 120 associated with them, and all motherboards 120 handle a single shelf 110. This pairing is referred to as “Shelf/Motherboard 110/120. All active shelves/motherboards 110/120 are polled asynchronously and concurrently; and every facing/photoresistor chain is polled either synchronously or asynchronously and concurrently depending on the architecture of the motherboard 120 and its firmware. Concurrent is an accurate term in describing the process, because it doesn't refer to computer execution, it refers to the process of polling the motherboards/facing. There is enough “waiting time” between a request for a signal and receiving the signal to “fit in” the activity of polling another component. If this was done sequentially, it would be incredibly slow, and would get dramatically slower with more motherboards added to the network (i.e., would not scale well)

The Motherboard State Polling Module 904 passes raw photoresistor chain data to a Data Mapping and Transformation Module 905. Data Mapping and Transformation Module 905 formats the raw data according to a Photoresistor Chain Mapping procedure and may add metadata or otherwise manipulate the positioning of raw data to a format required by the structure of cloud database 178. The Motherboard State Polling Module 904 then checks a List of Latest Photoresistor Values 906, which will be empty upon module startup, and if the present data is different from the latest photoresistor values for the presently processed active facing. The Motherboard State Polling Module 904 passes the data to the Data Mapping and Transformation Module 905 which will process the data and write the changed value to cloud database 178. The Motherboard State Polling Module 904 then updates the List of Latest Photoresistor Values 970, which the Motherboard State Polling Module 904 will then read at the beginning of the next motherboard state polling cycle.

### Plug-and-Play

FIG. 10 is an exploded top view of track 115A, with PCB 117A, which shows photoresistors 125A of PCB 117A distributed and connected along the length of track 115A. Features of shelf 110 being introduced in FIG. 10 include a 4-copper wire channel 1005, a rear extrusion 1007, a track connection slot 1008, a rear stop 1010, an upright 1015, an end PCB 1020, an end cap 1025; a pegboard 1030, 4 data and power end conductors 1035, a front extrusion 1040, a landing zone 1045, a drainage hole 1050, a shelf surface 1055, and a roller track base 1060.

Photoresistors 125A are on PCB 117A, which is disposed underneath rollers 111A such that photoresistors 125A will not be in contact with any merchandise placed on rollers 111A.

FIG. 11 is an exploded side view of track 115A with motherboard 120. Features being introduced in FIG. 11 include locking flanges 1102, a LAN cord plug 1105, a LAN bus 1107, a lock rod 1110, an extrusion base 1115, locking pin slots 1117, 4 data and power plug pins 1120, and a roller support bar 1130.

Rear extrusion 1007 includes extrusion base 1115, rear stop 1010, 4-cooper wire channel 1005, end PCB 1020, end cap 1025, locking rod 1110, and locking flanges 1102. End PCB 1020 works with 4 data and power end conductors 1035 together as an integral unit to connect motherboard 120. End cap 1025 is this integral unit's container to situate on shelf surface 1055.

Referring to FIGS. 10 and 11, photoresistors 125A produce signals based on the presence of merchandise on rollers 111A, and the magnitude of signal will be changed when the merchandise on rollers 111A moves from its original position. All signals (data) from PCB 117A communicate with motherboard 120 through data and power plug pins 1120, 4 data and power end conductors 1035, and end PCB 1020.

4 copper wire channel 1005 is configured to accept a tight insertion of 4 data and power end conductors 1035 for 4 data and power plug pins 1120, i.e., one pair for power supply and one pair for data transfer, for a total of 4 pins. In practice, the numbers of pairs of pins can be 6, 7, 8 or more, an odd number or an even number. PCB 117A connects to 4 data and power conductors 1035. In addition, FIG. 11 shows motherboard 120 affixed to rear stop 1010, and its location between rear stop 1010 and a gondola pegboard, i.e., pegboard 1030. Motherboard 120 has 4 PoE LAN cord plugs 1105 for data communication and power supply.

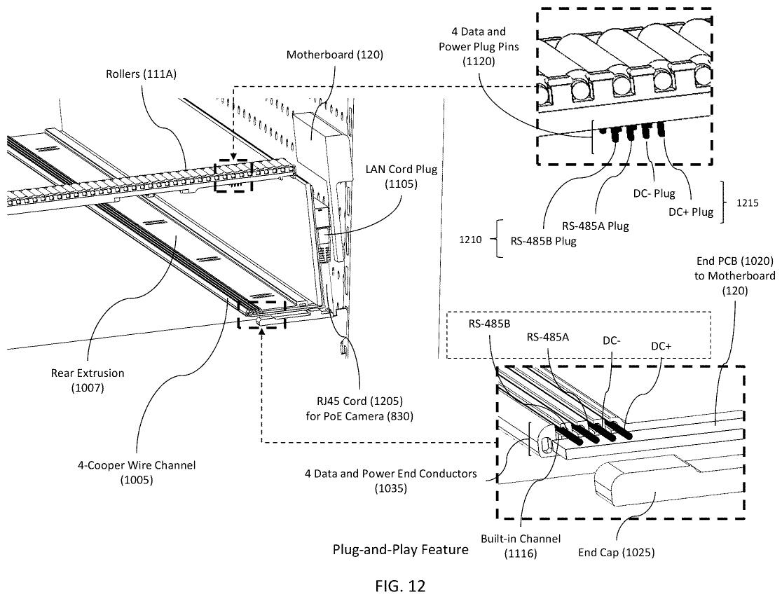

FIG. 12 is an illustration of some features of plug-and-play system 121. Plug-and-play system 121 electronically will connect 4 data and power plug pins 1120 from rollers 111A and photoresistors (not shown in FIG. 12) to horizontally disposed 4 data and power end conductors 1035. In this regard, FIG. 12 shows that 4 data and power plug pins 1120 include one pair of DC power supply pins 1215, i.e., DC− plug and DC+ plug, and one pair of data pins 1210, i.e., RS-485A plug and RS-485B plug. Accordingly, in 4-copper wire channel 1005, there are four slots to accept four plugs, respectively. In addition, an RJ45 cord 1205 for PoE camera 830 is connected to LAN cord plug 1105. End PCB 1020 is designed to connect with motherboard 120.

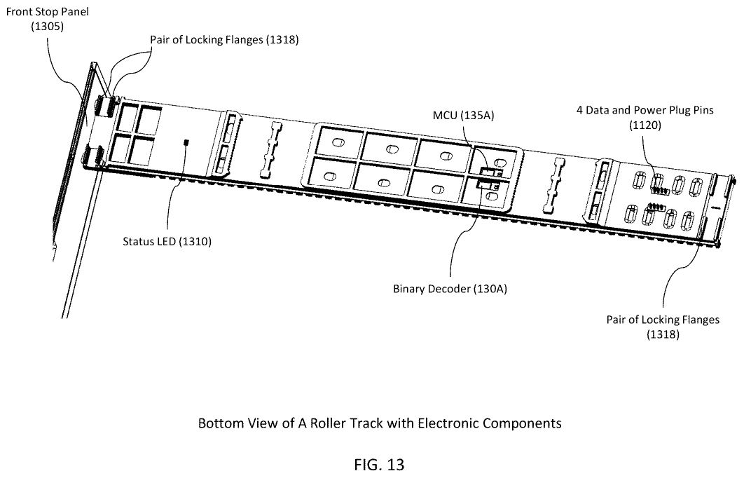

FIG. 13 is a bottom view of track 115A, with electronic components, adjacent to a front stop panel 1305. Two pairs of locking flanges 1318 lock onto rear extrusion 1007 (not-shown in FIG. 10) and secure track 115A onto front extrusion 1040 (shown in FIG. 10). A status LED 1310, MCU 135A and binary decoder 130A-1 are situated on the bottom of PCB 117A and above the bottom of track 115A (not shown in FIG. 13), and two sets of data and power plug pins 1120 on the bottom of track 115A.

FIG. 14 is a block diagram of a wiring system of a shelf network, specifying motherboard 120, tracks 115, LED strips/lighting panels 855, PoE camera 830, and PoE AP 825 devices. PoE AP 825 is used for positioning and provides WLAN (wireless local area network) links for other electronic devices, e.g., a cell phone, etc.

FIG. 14 shows shelf network communications, including wiring and protocols.

There are three types of shelf network: Type A, Type B, and Type C.

Type A is for power supply and data communication from tracks to motherboards. As shown in the left of FIG. 14, including one DC+ power supply, one DC− power supply, one RS-485A, and one RS-485B through power bus and RS-485 bus, respectively. All data are transferred from motherboard 120 to access server 150, then to cloud database 178 through network switch component 810 and RJ45 port 805 (TCP/IP), as shown in FIG. 8.

Type B is for power supply and lighting data communication on a shelf as shown in the middle of FIG. 14 including one DC+ power supply, one DC− power supply, one RS-485A, and one RS-485B through power bus and RS-485 bus, respectively. Again, all data are transferred from motherboard 120 to access server 150, then to cloud database 178 through network switch component 810 and RJ45 port 805 (TCP/IP), as shown in FIG. 8.

Type C is for electric/electronic devices such as PoE camera 830 and PoE AP 825, as shown in the right of FIG. 14. All data are connected to RJ45 port 805 through an Ethernet bus, and then transferred to cloud database 178 through access server 150.

The structures in detail of RS-485 Bus 1420 and Power Bus 1450 in FIG. 14 are shown in FIG. 12 as a feature of the Plug-and-Play system.

Real-Time Planogram (RT-POG) is the results of centralized and cloud-database, real-time, on-shelf merchandise inventory monitoring system in stores.

### Access Point (AP), 5G/6G Extender and Cameras

FIG. 15 is a bottom view of a gondola 1501 with electronic devices. Gondola 1501 includes cameras 1550 and 1505, an AP 1510, a motherboard 1512, a 5G extender 1515, a motherboard 1520, a deck 1525, lighting panels 1530, a shelf 1535, merchandise 1540, and a shelf 1545.

AP 1510 is located on the bottom of shelf 1545. The Ethernet is connected to motherboard 1512 through a network cable. The communication protocol is the PoE standard of 802.3af/at. The MAC, i.e., medium access control, of AP 1510 is recorded in access server 150 and is associated with a gondola ID so that when a wireless device (desktop, mobile, wearable, or other specialized devices), is connected to the Ethernet through the IP, it can record that the wireless device is near gondola 1501. However, a workable distance is needed to calculate the RSSI (i.e., Received Signal Strength Indicator) of a wireless communication network signal, for example, based on IEEE 802.11. An AP, such as AP 1510, does not need to be installed on each shelf, but instead, only a subset of the shelves.

Digital cameras 1550 and 1505, either with regular lens or wide-angle lens, are placed on the underside or on the surface of shelf 1545, behind or on its front stop edge. The number of cameras per shelf can be zero, one or more, or one camera can work vertically for several shelves in a row. The camera(s) are used to monitor the front-most merchandise on shelves, either on the same side or crossing on the opposite side of an aisle between two lines of gondolas. Digital camera(s) visualize and record front-most merchandise as images which can be identified and classified with 99% accuracy through ML (machine learning) AI, such as CNN (Convolutional Neural Network) where the ML's processing comprises three steps: convolution, max polling, and full connection. The digital camera for image and data processing can be integrated as one unit or separated into two parts, wherein one part is of a small size comprising lens and image sensor, and can be embedded near the front stop, and the other part comprising image converter, Ethernet convertor, DC-to-DC converter and other devices can be placed in another position such as the bottom of the shelf. Sufficient pixels are necessary, say, 2 M to 5 M, within images, for the abovementioned ML processing to achieve a high level of accuracy in its results. In FIG. 8 there is a PoE Camera 830 that processes data and transfers the data to Access Server 150 through Network Port 805, e.g., RJ45 Port (TCP/IP).

When 5G extender 1515 is connected to the RJ45 port of motherboard 1520, 5G extender 1515 uses 802.3af/at power supply and only serves as a PD (power device) extending an outdoor 5G signal to within a store, e.g., store 101.

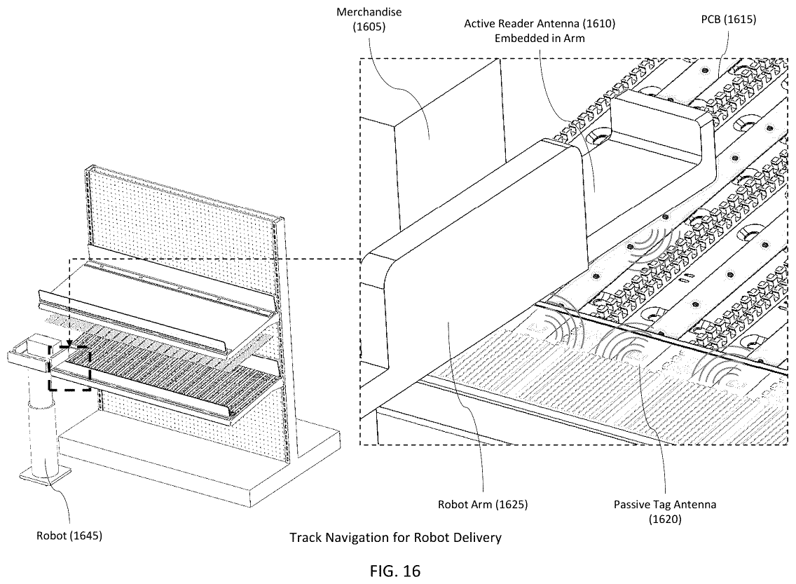

FIG. 16 is an illustration of track navigation for a robot 1645 to deliver merchandise 1605 to a track by use of ultrahigh frequency radio frequency identification (UHF RFID) technology. There is a UHF RFID tag chip and antenna on each PCB, e.g., a passive tag antenna 1620 on a PCB 1615, with a working frequency band 902-928 MHz. UHF RFID can use other frequency bands, but must comply with local governmental regulations, such as 865-868 MHz in Europe. The UHF RFID tag, e.g., passive tag antenna 1620, for each track has an independent ID recorded in central cloud database 178, and is associated with the location of the track, i.e., facing for robot arm 1645 to replenish merchandise in accordance with an order from cloud database API 177. A robot capable of pick-and-place performance with sufficient accuracy is required.

As robot 1645 arrives near a gondola that needs merchandise restocking, robot 1645 opens a UHF RFID antenna 1610 that is embedded in a robot arm 1625 and performs an active group scan of nearby UHF RFID tags, e.g., nearby passive tag antennas, such as passive tag antenna 1620, and finds the RFID Tag ID that needs to be restocked through communication with access server 150 and those IDs on adjacent tracks. RSSI obtained by scanning these three or more RFID tags performs a three-point positioning calculation so that robot 1645 can accurately find the track and restock merchandise needed on the track.

Data supplied to robot 1645 includes:
(A) a navigation map is accessed through the Robotic Navigation API of the Application API 179 for merchandise replenishment by robot 1645;
(B) real-time inventory of merchandise is accessed through the RT-POG API of the Application API 179;
(C) gondola positioning signals generated by an AP/5G extender; and
(D) track positioning signals passively responded by RFID to robot's searching signals associated with the track.

Navigation and software can be based on gondola ID, shelf ID and track ID.

FIG. 17 is an illustration of real-time, on-shelf inventory represented in a RT-POG.

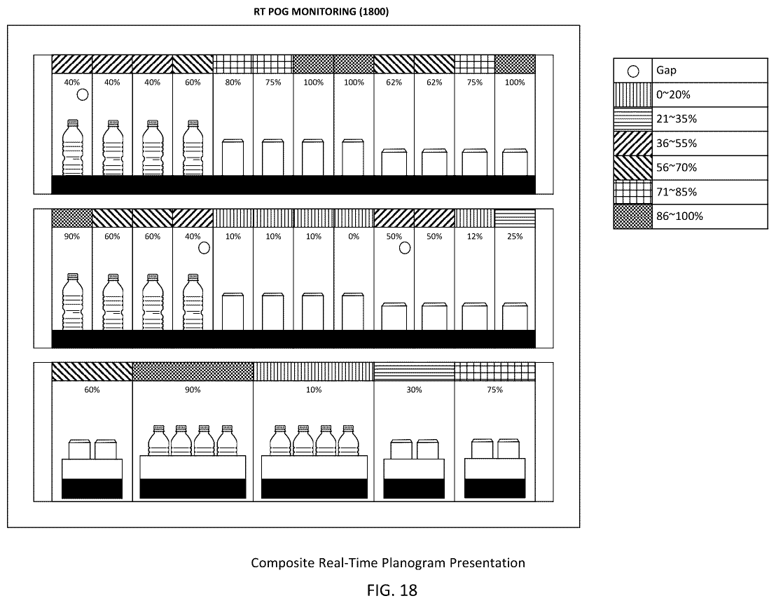

FIG. 18 is an RT-POG presentation.

When presenting retail store managers with real-time on-shelf inventory, the data must be organized in a readable and easily relatable format. For store staff involved in restocking product items and maintaining the condition of shelves and facings, product type and location are important data. This information must be presented in a format that is familiar and instantly understood by people in need of this type of data.

By showing real-time on-shelf inventory within the schema of a standard POG, information is presented in a format familiar to people working in retail, making it easy for store staff involved in restocking product items and maintaining the condition of shelves and facings to replenish inventory as needed, and correcting shelving and facing conditions such as out-of-position product items, gaps between product items, and product items missing from the front of facings.

Real-time on-shelf inventory is displayed as a percentage amount, and gaps between product items and product items missing from the front of facings are displayed as circles whose size and position corresponds to real-time shelving and facing conditions.

In addition, on-shelf inventory percentages are color coded so that low inventory amounts can be easily seen.

FIG. 17 shows a cross sectional view of a shelf with 70% inventory (by shelf capacity/product), i.e., view 1710, a gap condition where there is significant space between two product items, i.e., view 1720, and a condition where a product item is lying down on the shelf instead of being in the upright position, i.e., view 1730. In each situation, a percentage inventory is displayed, although the percentage may be inaccurate or misleading under the conditions represented by view 1720 and view 1730.

FIG. 18 shows a simplified user interface for an RT-POG 1800. Display fixtures, shelves and facings are displayed with a photo and text indicating products assigned to shelves and facings by the store's POG. Inventory is color coded, with cooler colors indicating sufficient inventory, and warmer colors indicating a need to restock

The inventory level is defined as the percentage of inventory of a specified category/section in a given store without empty or without getting warning. For example, if there are 100 gondolas in a single-serve beverage section, with shelves 48″ wide×22″ deep, and 100 tracks per shelf for a total of 10,000 tracks in the single-serve beverage section, then, 20% means 80% of shelves are empty or have inventory less than a warning quantity, say 20%. For consistency, use colors by the same definition as those in the RT-POG, i.e., 0% to 20% in red, 21% to 40% in orange, 41% to 60% in yellow, 61% to 80% in green, 81% to 100% in blue.

A given point (circle) represents a store and selecting the point, e.g., touching the point on a touch screen display, will reveal the store number.

The category or section of a given store can be selected. Herein, section is defined as a sub-division under category. For example, under the category of health and wellness products, there are subdivisions for allergy and sinus, cough and cold, diabetes OTC, eye care, oral care, sleeping and snoring, and vitamins and supplements.

Information is delivered to HQ and related departments selected by HQ by use of an RT-POG.

Data collected are partially listed below, such as:
(1) Real-time inventory based on RT-POG;
(2) Conditions of displayed merchandise in real time;
(3) Sales and revenue in real time;
(4) Cashflow; and
(5) Records of sales history.

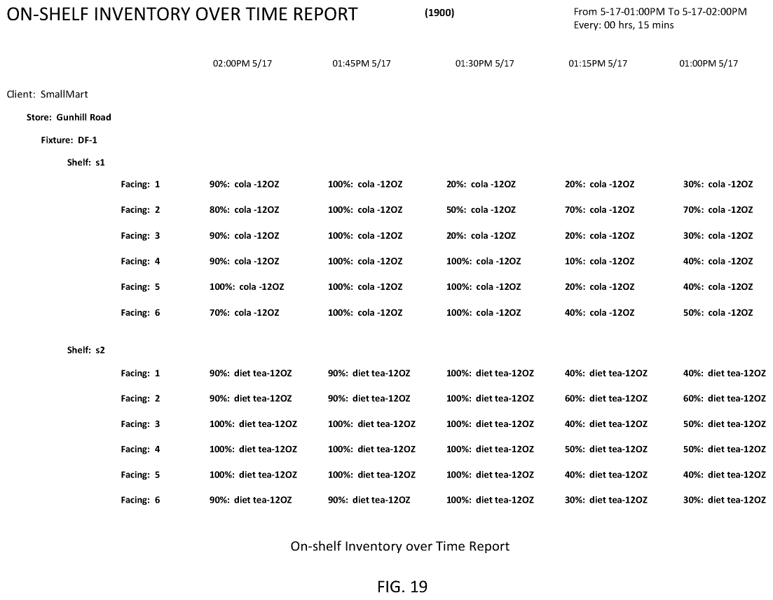

FIG. 19 is an on-shelf inventory over time report 1900. An on-shelf inventory over time report shows inventory states at specified regular time intervals over a specified time range. Data can be selected, grouped and sorted according to user-specified parameters. For example, the report could be grouped and sorted by product for all facings in all stores or grouped by shelves selected for a single store.

In FIG. 19, a report is selected for all facings in a store, ungrouped, and sorted by fixture, shelf and facing. The time range is for a period that starts on 1:00 pm on May 17, 2022 and ends at 2:00 pm on the same date. Inventory is reported for all intervals of 15 minutes that fall between and include the starting and ending time range. FIG. 19 is a report 1900 for a single business day of a store, grouped and sorted by product, with the inventory over time data represented graphically using a line chart.

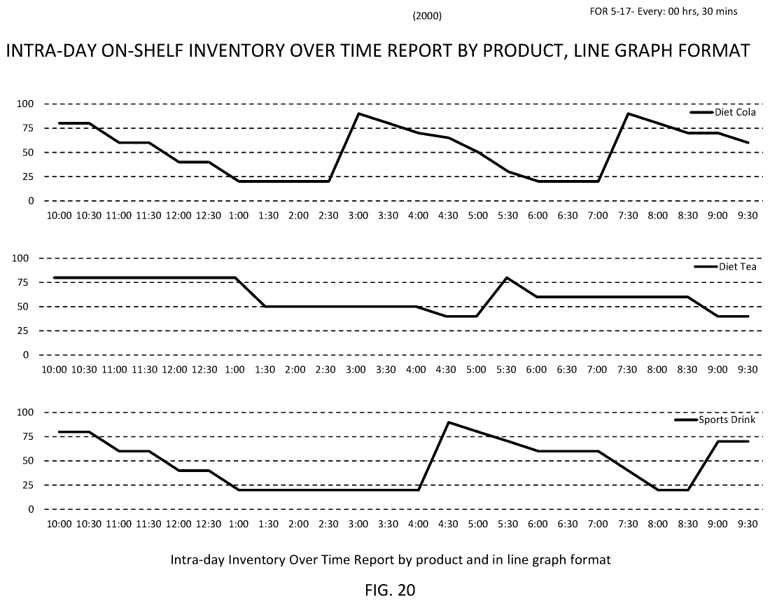

In FIG. 20, an intra-day on-shelf inventory over time report by product, line graph format 2000 shows several exemplary time-inventory on-shelf curves.

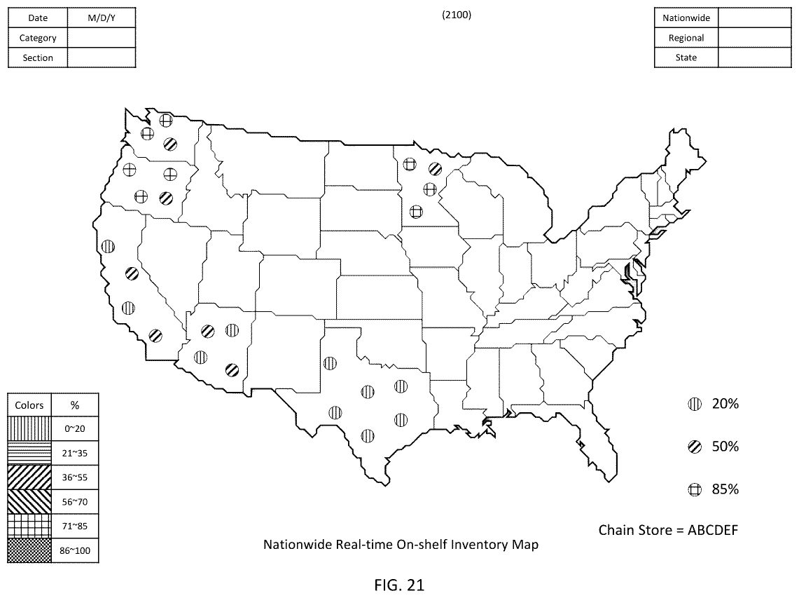

FIG. 21 is a nationwide inventory map 2100 showing real-time on-shelf inventory levels in the form of a nationwide map of the continental United States. Information is delivered to chain stores HQ through an RT-POG and a real-time on-shelf inventory map.

The Inventory Map is a geographic (nationwide or regional) and displays all stores by store ID (including chain stores or branded items), whether owned by the user or selling for brands, and real-time on-shelf inventories of merchandise by percentages in colors.

Some components of the map structure are:
(1) Geographic hierarchy: countries, regions, states, counties, cities and/or towns;
(2) Users: chain stores, brand makers.
(3) Supply chains: suppliers, vendors, warehouses, delivery services and others;
(4) Merchandise: stores, categories, sections, branded items, packages;
(5) Displays: gondola systems, racking systems, walk-in-door coolers, etc.
(6) POGs: RT-POG;
(7) Inventory levels on shelf: represented by colors; and
(8) ID numbers: Each item has a unique ID number.

Descriptions of Features of the Quantum system have been present above.

From the above descriptions based on photoresistors used as perception, one can see a complete structure of a cloud-based Quantum system interpreted by a visual image, and its powerful functions to monitor real-time merchandise inventory on shelving system.

In the Quantum system, analog/digital signals and Real-time Inventory Data transfer from a lower level to a higher level though connections βₚₐ, β_{ad}, β_{de}, β_{ec}, or β_{cc1}. Digital signals are sent to a Local Access Server and Signal Processing Software, where they are then converted to Real-time Inventory Data and transferred to the cloud database of cloud layer/shell α_{c}, where requests from client apps and processes for Real-time Inventory Data can be received by the cloud database via the public API.

The techniques described herein are exemplary and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprise” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A system that is centralized and cloud-based, for monitoring on-shelf merchandise inventory and conditions in real-time, said system comprising:
a shelving component comprising:
(a) a shelf comprising:
a track upon which said merchandise is moveably disposed;
a motherboard having a network port; and
a plug-and-play component which comprises data and power conductors which enable the communication of information between said motherboard and said track;
(b) a plurality of photoresistors disposed in proximity to said track, wherein said photoresistors produce analog signals indicative of a quantity of said merchandise disposed on said track at any moment in time;
(c) a unique identifier associated with at least one component selected from the group consisting of one of said photoresistors, a group of said photoresistors, said track, said motherboard, said plug-and-play component, and said shelf;
(d) a binary decoder disposed on said track for polling said analog signals of each of said photoresistors; and
(e) a microcontroller unit (MCU) disposed on said track, said MCU comprising a track application program interface (API), an analog to digital converter port for analog signal input, and an analog signal to digital signal converter,
wherein said motherboard is disposed on said shelf for shelf Ethernet networking and for track connection though a network bus and a power bus via said plug-and play-system; and
an access server connected to said shelving component via said network port of said motherboard, wherein said access server sends a request to scan each of said photoresistors to said MCU through said motherboard, then said access server sends a request through said motherboard to said MCU to retrieve the analog signals from said photoresistors,
wherein said MCU then converts said analog signals to digital signals via said analog signal to digital signal converter, such that said digital signals are transmitted via said plug-and-play component to said motherboard and then to said access server via said network port;
wherein said access server comprises a system that writes processed on-shelf inventory data to a cloud database; and
wherein said cloud database stores and organizes data from the access server, and through an API server, or several API servers, allows access of said data to client apps and processes able to send requests to, and receive data from said API servers associated with the cloud database,
wherein said plug-and-play component comprises:
a plug-and-play-main channel comprising:
(i) at least four built-in channels;
(ii) at least four embedded data and power conductors;
(iii) at least four pins on a connector of said track of said shelf to communicate information between said motherboard and each photoresistor on said track;
(iv) power buses; and
(v) the data link based on the connections of N nodes in a multipoint network such as the RS-485 buses,
wherein said plug-and-play-channel further comprises: (i) at least four conductive wire channels, (ii) track plug pins corresponding to the number of conductive wires, (iii) power buses, and (iv) the data link based on the connections of N nodes in a multi-point network such as the RS-485 buses, and (v) an end PCB to connect to the motherboard of said track,
wherein said plug-and-play component electronically connects 4 data and power plug pins from rollers and photoresistors to 4 horizontally disposed data and power conductors;
wherein 4 data and power plug pins include one pair of DC power supply pins, and one pair of data pins, and
wherein, in the four conductive wire channels, there are four slots or four pairs of slots to accept four plugs, respectively.

2. The system of claim 1, wherein said access server thereafter performs the following operations:
retrieving a generated threshold for each of said photoresistors from said cloud database;
retrieving an initial uncovered digitized voltage value for each of said photoresistors and calibrating its threshold;
converting said digitized voltage value received from said motherboard to covered/uncovered values in said access server;
mapping said covered/uncovered values of said photoresistors to match physical dimensions of said merchandise disposed on said track;
adjusting said mapping of covered/uncovered values for anomalies using artificial intelligence techniques based on machine learning; and
calculating a percentage of said merchandise on said track, thereby forming processed data; and uploading said processed data to said cloud database.

3. The system of claim 2, further comprising:
a cloud server that houses said cloud database;
wherein said cloud server comprises a cloud database API and an application API, connects access server software via hypertext transfer protocol (HTTP), and connects client apps and processes via HTTP.

4. The system of claim 3, wherein said processed data and various permutations of said processed data can be retrieved through said cloud database API by at least one client selected from the group consisting of a remote inventory monitoring application, a merchandise stocking robot, a delivery logistics application, and a data mining and analysis system.

5. The system of claim 1,
wherein said track is configured as an individual longitudinal track having a bottom surface, a left side, a right side, a front end and a rear end, and
wherein said shelf further comprises a printed circuit board (PCB) situated along said individual longitudinal track, and having said photoresistors, said binary decoder, and said MCU installed thereon, and access through said track API, under ambient or non-ambient light, to track said merchandise.

6. The system of claim 1,
wherein said shelf comprises a surface, a bottom, a left side, a right side, a front end, a rear end, a front stop, a rear stop, at least two tracks, at least two dividers, and a support,
wherein said support comprises: (i) at least one beam that crosses a width of said bottom, (ii) a left bracket, (iii) a right bracket, and (iv) a vertical wall and a pair of uprights as a gondola shelving component or similar,
wherein said support comprises: (i) a wire grid as a surface, or at least one beam that crosses a width of said bottom, (ii) a left wire or beam at left edge, (iii) a right wire or beam at right edge, and (iv) a vertical upright support as a racking system or similar,
wherein said motherboard comprises electronic components for data communications,
wherein said at least four embedded data and power conductors are situated on said surface of said shelf, for data transfer between said at least two tracks and said motherboard through a serial communication bus,
wherein said plug-and-play component works for at least one configuration selected from the group consisting of multiple individual longitudinal tracks of photoresistors, and a non-individual longitudinal track with photoresistors.

7. The system of claim 1,
wherein said analog signals produced by said photoresistors are converted to said digital signals for data processing through a retrieval process by said binary decoder under control of said MCU,
wherein said shelf holds a quantity of said photoresistors equal to N×M,
wherein N is a quantity of said photoresistors along a depth of said track,
wherein M is a quantity of tracks along a width of said shelf, and
wherein N can be any integer greater than 0, where N>768 is sufficient in most cases.

8. The system of claim 1,
wherein said photoresistors are organized by multiple levels of binary decoders controlled by said MCU, and
wherein a quantity of said multiple levels is used to adapt a quantity of photoresistors.

9. The system of claim 1,
wherein said system employs a data communication network that is configured for a serial communication bus for said track and Ethernet for said shelf's motherboard;
wherein said plug-and-play component is configured for communicating the shelf's motherboard and with said tracks on said shelf;
wherein said point is defined as said shelf's motherboard or said track as one of a serial communication bus for said track;
wherein said track is identified through methods such as scanning a unique ID encoded in a tape-like element such as a barcode adhered onto said track;
wherein the communication address of said track is preset and not related to said track's ordinal position on said shelf; and
wherein said communication among said shelf's motherboard and tracks is defined as non-point-to-point communication formation.

10. The system of claim 1,
wherein said system employs a data communication network that is configured for a serial communication bus for said track and Ethernet for said shelf's motherboard;
wherein said plug-and-play component is configured for communicating the shelf's motherboard and with said tracks on said shelf;
wherein said point is defined as said shelf's motherboard or one of a number of fixed segment devices such as sockets along the width of said shelf;
wherein said track is identified by polling said fixed sockets or segment devices, and for newly plugged-in tracks, reading a unique ID stored in said track's internal memory through communication with said fixed socket or segment device;
wherein the communication address of said track is automatically set to the fixed socket's or segment device's ordinal position and therefore said track's ordinal position can be determined, as well as its general location relative to the leftmost or rightmost edge of said shelf; and
wherein said communication among said shelf's motherboard and tracks via said fixed sockets or segment devices is defined as point-to-point communication formation.

11. The system of claim 1,
wherein said method of mapping photoresistors comprises:
a cloud, edge, or local database comprising:
data related to specifications of said tracks, planogram data, and
data related to the physical dimensions of merchandise items;
a data stream comprising signals from said tracks; and
an algorithm for mapping photoresistors to product dimensions using said cloud, edge, or local database and its data,
wherein said method of mapping photoresistors allows exact on-shelf-inventory percentage readings for various product items using a fixed and limited number of photoresistors on a track, and
wherein anomalies in the condition of said product items on the shelfs such as gaps between product items and the presence of said product items arranged in disarray are detected and adjusted for through AI techniques such as supervised machine learning, unsupervised machine learning, and semi-supervised machine learning.

12. The system of claim 1,
wherein said motherboard comprises:
network switch components; and
power management components,
wherein said network switch components:
extend connections with serial port management components and light emitting diode (LED) chips on said tracks through serial-port-to-Ethernet-conversion components of said MCU, and
extend connections through said network port, with power sourcing equipment (PSE) components, and at least one component selected from the group consisting of a Power Over Ethernet (POE) access point, and a PoE camera, 5G extender, 6G extender,
wherein said power management components on said motherboard transfer power from said shelf to said track, and at least one component selected from the group consisting of an LED strip, a lighting panel, a power adapter, a network port through PSE, and serial port management components of MCU for data communication, and
wherein said system further comprises a link between said shelf and said access server through said network port.

13. The system of claim 1, further comprising a wiring and protocol system of network communications through:
a serial communication bus between said track and said motherboard;
an Ethernet bus between said motherboard and said access server; and
components that utilize hypertext transfer protocol (HTTP) for communications between said access server and a cloud server,
wherein said network communications include:
(1) power supply and data communication from said track to said motherboard;
(2) power supply and lighting data on said shelf; and
(3) power supply for electric/electronic devices.

14. The system of claim 1, wherein said system utilizes:
a serial communication bus between said track and said shelf;
Ethernet between said shelf and said access server;
hypertext transfer protocol (HTTP) between said access server and a cloud server; and
HTTP between said cloud server and a client app or process.

15. The system of claim 1, wherein said shelf further comprises:
electric/electronic components for data collection and communications in an Ethernet environment; wherein said electric/electronic components include at least one device selected from the group consisting of an access point (AP), a 5G/6G extender, said motherboard, a lighting panel, and a camera; and
a serial communication bus to transfer data collected from said track to said shelf though said plug-and-play component,
wherein said data is produced by said photoresistors, and
wherein said motherboard includes said network port for communications via an Ethernet bus between said shelf and said access server.

16. The system of claim 1,
wherein said shelf comprises digital cameras placed in relevant positions to recognize said merchandise, each track matched to the POG by use of AI technology including CNN (Convolutional Neural Network),
wherein at least one said digital camera in a fixed position monitors one or more tracks of said shelf,
wherein at least one said digital camera is placed at a relevant position, either on the same shelf or at the shelf on the opposite side of the aisle,
wherein one camera visualizes, and shoots merchandise installed on at least one shelf crossing on the opposite side of the aisle,
wherein one digital camera can be placed near the bottom of the front stop to monitor the front-most merchandise on each track,
wherein a movable digital camera replaces said fixed-position camera to scan the width of said shelf,
wherein one camera captures images with a sufficient number of pixels,
wherein said images of front-most merchandise on each track can be photographed by said wide angle lens and reformed,
wherein said one digital camera comprises two parts: the lens and image sensor(s), and the other part comprises the image converter, Ethernet converter, DC-to-DC converter, and/or other device(s); and
wherein said one digital camera is one integral unit comprising the two above said parts.

17. The system of claim 1,
wherein said shelf further comprises an access point (AP) for data communications through said network port,
wherein said shelf accommodates a wireless device to connect to an Ethernet environment through said access point,
wherein said access server records a medium access control that is associated with a gondola ID,
wherein said wireless device is connected to the Ethernet through an internet protocol, and said access server records that said wireless device is near said gondola, and
wherein said AP is utilized for navigation of said wireless device.

18. The system of claim 1,
wherein said shelf further comprises a 5G/6G extender for data communications through said network port,
wherein said shelf accommodates a wireless device to connect to an Ethernet environment through said 5G/6G extender,
wherein said 5G/6G extender is connected to said network port and serves as a power device to extend a 5G/6G signal from outside a store to within said store, and
wherein said 5G/6G extender is utilized for navigation of said wireless device.

19. The system of claim 1,
wherein said shelf further comprises a printed circuit board having an ultrahigh frequency radio frequency identification (UHF RFID) tag chip and an antenna,
wherein said UHF RFID tag chip has an independent identification recorded in said cloud database, and is associated with a location of said track,
wherein said system further comprises:
a robot that:
receives instructions from said cloud database to deliver merchandise to said shelf;
opens an UHF RFID antenna that is embedded in an arm of said robot;
performs an active group scan of UHF RFID tags;
utilizes Received Signal Strength Indicators (RSSIs) obtained from three or more of said UHF RFID tags, and based thereon, finds said UHF RFID tag chip of said shelf, and thus locates said track; and
delivers said merchandise to said track.

20. The system of claim 19, wherein said robot utilizes at least one data item view selected from the group consisting of:
(a) a navigation map;
(b) real-time on shelf inventory of merchandise;
(c) gondola positioning signals generated by an Access Points (AP) and/or 5G/6G extender;
(d) track positioning signals passively responded by RFID to searching signals of said robot associated with said track;
(e) a gondola ID;
(f) a shelf ID or a mother board ID; and
(g) a track ID.

21. The system of claim 1,
wherein said system utilizes a unique global identification (ID) for a component in said system,
wherein said unique global identification is configured with 2 base-62 digits determined by component type for said component, followed by 7 base-62 digits that are randomly selected and tested for uniqueness, and 1 base-62-digit checksum to ensure data integrity upon network transmission.

22. The system of claim 1, further comprising:
a polling/scanning module that retrieves digital signals derived from said photoresistors;
a photoresistor mapping module that maps said photoresistors to physical dimensions of merchandise that is currently on said track; and
a module that determines thresholds to be applied in conversions from said digital signals to discrete covered/uncovered values, wherein said thresholds are determined using at least one data set selected from the group consisting of:
(a) a pre-determined threshold value for merchandise type;
(b) an artificial intelligence adjusted threshold value using machine learning derived from tagged training data;
(c) an adjusted threshold based on an always-uncovered control photoresistor on said track;
(d) information from a calibration module that further adjusts a threshold value with an addition of an initial uncovered value of each of said photoresistors recorded upon installation of said track; and
(e) information from a data writing module that applies mapping and threshold values to data, and writes said data to said cloud database.

23. The system of claim 1, wherein said cloud database contains at least one data view selected from the group consisting of:
(a) real-time on-shelf merchandise inventory data represented as percentage or non-percentage values;
(b) historical on-shelf merchandise inventory represented through a table, chart or other formation;
(c) real-time on shelf merchandise inventory displayed geographically by store, region, division, country, or globally;
(d) real-time on-shelf merchandise inventory of an individual store by category, section, department, shelving system or others related grouping;
(e) merchandise, product and brand data;
(f) client data;
(g) motherboard, track, MCU, binary decode, photoresistor or sensor meta data;
(h) plug and play, camera, LED strip/panel, access point, RFID and other device meta data; and
(i) other supporting physical device meta data.

24. The system of claim 1, wherein said system provides, to a user's device, a collection of predefined views that deliver data to said user's device, to facilitate visualization of real-time on-shelf inventory in at least one format selected from the group consisting of a planogram format used in notification, a historical format, and any number of user defined or requested analytical reports.

25. The system of claim 24, wherein said system employs an application program interface for said cloud database that allows a user of a client app or process to access data from said cloud database and view said accessed data in accordance with said predefined views.

26. The system of claim 1, wherein said system employs an application program interface for said cloud database that serves a list of restocking commands, ordered by a priority determined by geography, movement of a particular merchandise or other factors, to a robotic device, a driverless delivery system, a human operator, or any other process involved with replenishing on-shelf inventory.

27. The system of claim 1,
wherein said network port is a Transmission Control Protocol/Internet Protocol (TCP/IP) port, and
wherein said network port is an Ethernet port.

28. The system of claim 1, configured in accordance with a general-purpose Quantum system.
